(19) United States
(12) Patent Application Publication
(10) Pub. No.: US 2005/0047713 A1
(43) Pub. Date: Mar. 3, 2005

(54) Process of optical WDM bus networking with DWDM expansion for the method of protected point to point, point to multipoint and broadcast connections

(76) Inventor: Roman Antosik, Colts Neck, NJ (US)

Correspondence Address: ROMAN ANTOSIK, 16 OXFORD KEY, COLTS NECK, NJ, 07722, US

(21) Appl. No.: 10/650,390

(22) Filed: Aug. 28, 2003

(51) Int. Cl. G02B 6/28

(52) U.S. Cl. 385/24

(57) ABSTRACT

A process for all-optical multi-bus networking of two-fiber bidirectional buses with two-fiber bidirectional Bus-To-Bus Links for a method of shared mesh protected Point-To-Point, Point-To-Multipoint and Broadcast Networking with the steps of: providing protected Bus-To-Bus service networking and Bus-To-Bus protection networking and in-service expansion with more buses, in place of networking with isolated rings connected through un-protected ring-to-ring connections, providing capacity expansion by replacement of single Wavelength Division Multiplexed (WDM) optical signals in few, wide bandwidth WDM channels with a plurality of optical signals Dense Wavelength Division Multiplexed (DWDM) to each WDM channel, and switching few WDM optical channels with small size modular Switching Fabrics, in place of high startup-cost, high capacity DWDM systems switching many DWDM optical signals with expensive and unreliable large size Switching Fabrics, providing the Add/Drop capability integrated with the Append/Drop-Continue capability, to Append more DWDM optical signals to a WDM channel already partially occupied by DWDM optical signals at non overlapping carrier frequencies, in place of requiring to Drop those signals before new ones could be Added, providing optical switching capability integrated with selective broadcast capability of Added or arriving at the Bus or the Bus-To-Bus input terminals WDM channels in place of using external optical Power Couplers with reduced transmission reach, providing one local, shared mesh protection with bus protection loops integrated with dedicated 1+1 Dual Bus Interworking protection to protect Bus Link failures, Bus-to-Bus Link failures, and Switching Fabrics and other equipment failures with reserved as low as 25% of protection bandwidths, in place of ring protection with 50% of reserved protection bandwidth and un-protected ring-to-ring connections.

### BACKGROUND OF THE INVENTION

This invention relates to the field of optical communications and more specifically to the process of all-optical, bit-rate and format transparent, scalable multi-bus Wavelength Division Multiplexed (WDM) networking with in-service Dense Wavelength Division Multiplexed (DWDM) capacity expansion and design of Passive, Flexible and Switching Bus Interface Nodes for the method of shared mesh protection of Point-To-Point, Point-To-Multipoint and Broadcast Networking. Traditional Cable TV Networks (CATV) provide unidirectional TV Broadcast and more recently bidirectional Internet Access and fixed Video on Demand Services. Storage Area Networks (SAN) provide file storage for large customers. Internet Service Providers (ISP) use Local Area Networks (LAN) of up to three layers of: Gateway, Aggregation and Application Internet Protocol (IP) Routers to access the IP Network. The independent CATV, SAN and ISP networking does not allow creation of affordable and scalable services, such as flexible Video On Demand which requires integration of the Point-To-Point SAN networking for video storage and retrieval, ISP networking for video search, preview and request, and Broadcast CATV networking for video delivery. The invented multi-bus networking platform supports protected Point-To-Point, Point-To-Multipoint and Broadcast connections for creation of integrated ISP-SAN-CATV services.

High startup cost, high capacity DWDM Long Haul and Metro Systems are deployed for long reach and intermediate reach applications. Low startup cost, low capacity WDM and Course WDM (CWDM) Systems are deployed for short reach Access and intermediate reach Metro applications. Unpredictable traffic demands in diverse, local areas makes questionable deployment of both DWDM and WDM/CWDM systems because of fear of not being able to match network capacity with the traffic demand. The invented multi-bus networking platform is a low startup cost, low capacity WDM platform that is in-service, pay-as-you-grow expanded to the high-capacity DWDM network for creation of data-secure Virtual Private Networks sharing multi-bus bandwidth and resources. WDM Networks use Optical Multiplexers and Demultiplexers and Optical Switches to provision Point-To-Point connections what makes them unsuitable for multicast and broadcast applications. The invented multi-bus networking platform is a WDM Network with the protected Point-To-Point connections integrated with the protected Point-To-Multipoint and Broadcast connections.

Metro Networks use SONET/SDH rings for protection of fiber cuts and node failures. The rings are connected through ring-to-ring connections with external 1+1 Dual Ring Interworking protection. The ring networks are not easily scalable and not flexible enough to support distributed traffic growth in the Access and the Metro areas. The invented multi-bus platform is a bit-rate any format transparent, scalable, multi-layer platform of parallel or intersecting, open or closed buses connected through the Bus-to-Bus (BTB read B-to-B) Links, for common, shared mesh protection of both fiber-cuts and equipment failures, and for the BTB service routing.

DWDM Networks depend on expensive and unreliable, large size, Switching Fabrics for wavelength routing. The Switching Fabrics are duplicated for protection what makes it a double expensive solution. The invented multi-bus networking platform multiplexes a plurality of DWDM optical signals to each WDM channel switched with small size Switching Modules that are installed in-service in the pay-as-you-grow fashion. The Switching Modules are not duplicated; instead their failures and the fibercut failures are protected by the same shared, mesh protection loops.

Prior art networks support either only Point-To-Point or only Point-To-Multipoint connections protected by the rings with 50% of transmission bandwidth reserved for protection. Point-To-Point ring networks form the backbone of the Long Haul Networks and are being deployed in some Metro areas. Their design has been widely studied, and standardized by various SONET/SDH standards. The invented two-fiber, bidirectional multi-bus platform supports: Point-To-Point, Point-To-Multipoint and Broadcast types of connections protected by the mesh protection loops. The most similar way to achieve fiber-cut protection of Point-to-Multipoint connections was patented for one-fiber, unidirectional rings by Harstead; Edward E. (New York, N.Y.); Hazeu; Louis Viktor (Almere, NL) from Lucent Technologies Inc. in the patent: “Protection Scheme for Single Fiber Bidirectional Passive Optical Point-To-Multipoint Network Architectures“ and by Dyke; Peter John (Saffron Walden, GB); Dyer; Michael Philip (Stansted, GB) from Nortel Networks Ltd in the patent: “Passive Optical Network Arrangement”. Both designs use one-fiber ring protections of a unidirectional Point-To-Multipoint connection from a Head-end to a plurality of Terminals. The protection uses optical Power Taps for connecting each Terminal to the ring fiber. The one-fiber ring protection of unidirectional connections method differs from the invented two-fiber shared mesh protection of bidirectional connections.

F. Dorgeuille, and L. Noirie from Alcatel Research and Innovation, and A. Bisson from Alcatel CIT presented a two-fiber bidirectional ring protection of the Point-To-Multipoint connections at the Optical Fiber Conference (OFC) 2003 in the paper “40 km Passive Optical Metro-Access Ring (POMAR) Including a Protection Scheme Based on Bi-Directional Fibers”. In the method a two-fiber access ring with one HUB and 4 Access Nodes uses one fiber for the broadcast from the HUB to the Access Nodes in both ring directions, and another one for a switched transmission from each Access Node to the HUB in one ring direction only. The Access Nodes select one of the broadcasted to them signals with selection switches. The presented ring broadcast method differs from the invented multi-bus broadcasting method in which all bus Terminal Equipments have the HUB broadcast capability.

A method for DWDM capacity expansion of the CWDM systems was discussed at the Optical Fiber Conference (OFC) 2003 in the paper by P. Iannone, K Reichmann from AT&T Labs Research, and L. Spiekman from Genoa Corp. The authors describe a very wide-band Line Optical Amplifier (LOA) with the gain varied from 10 to 18 dB, capable of amplifying an 8 channel CWDM system with each CWDM channel expanded by 8 DWDM signals. Such amplifier could be used as an alternative amplification solution to the preferred embodiment with the narrow band optical amplifiers of individual WDM channels.

### BRIEF SUMMARY OF INVENTION

The primary object of the invention is to provide a method of shared mesh protection of Point-To-Point, Point-To-Multipoint, and Broadcast connections in the multi-bus platforms that is protocol and bit-rate transparent due to its all-optical design with no regeneration, no reshaping and no retiming, and no wavelength conversion.

Another object of the invention is to provide a method for scalable, in-service expansion with more buses of the multi-bus network.

Yet another object of the invention is to provide a method for one shared mesh protection of both Bus Link fiber-cuts and Switch Fabrics and other equipment failures with local, bus protection loops requiring as low as 25% of reserved bandwidth.

Yet another object of the invention is to provide a method for shared mesh protection of the BTB Link fiber-cuts with the bus protection loops integrated with the dedicated 1+1 Dual Bus Interworking (DBI) protection.

Still yet another object of the invention is to provide a method for in-service capacity expansion of the low start-up cost WDM multi-bus network with one WDM optical signal in each WDM channel, to the high capacity DWDM-expanded WDM multi-bus network with a plurality of DWDM optical signals optically multiplexed/demultiplexed to/from each WDM channel.

A further object of the invention is to provide a method of a multi-service platform for competitive service creation with data-secure Virtual Private Networks sharing multi-bus network transmission bandwidth.

Another object of the invention is to provide preferred embodiments of the Passive, and the Flexible Bus Interface Nodes and the invented preferred embodiment of the Switching Bus Interface Node for the multi-bus networking.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for all-optical multi-bus networking with one single wavelength WDM optical signal or a plurality of single-wavelength DWDM optical signals, called just DWDM signals, optically multiplexed/demultiplexed to/from each WDM channel for a method of mesh protected Point-To-Point, Point-To-Multipoint and Broadcast networking comprising the steps of: providing scalable networks of parallel or intersecting, closed or open, two-fiber bidirectional buses connected through two-fiber bidirectional BTB Links, providing Bus-To-Bus service and protection routing, providing two-fiber bidirectional buses with DWDM HUB Nodes for optical multiplexing and demultipexing of a plurality of DWDM signals to/from each WDM channel for in-service capacity expansion of the WDM multi-bus networks, providing two-fiber bidirectional buses with Passive, Flexible and Switching Bus Interface Nodes, rather than, like in the prior art, deploying a high startup cost, high capacity DWDM network or many low capacity WDM networks.

In accordance with a preferred embodiment of the invention, there is disclosed a Switching Bus Interface Node (SBIN Node) for a method of mesh protected Point-To-Point, Point-To-Multipoint and Broadcast Access and Metro networking comprising: providing two bidirectional Bus-To-Bus terminals for protected Bus-To-Bus service networking and Bus-To-Bus protection networking and for in-service expansion with more buses rather than, like in the prior art, using isolated rings connected through un-protected ring-to-ring connections, providing Switching Modules and optical Power Couplers for optical Add/Drop integrated with optical Append/Drop-Continue rather than, like in the prior art, requiring to Drop all signals before new ones could be Added, providing Switching Modules, BTB Switching Modules, and a BTB Broadcast Module for Wavelength Switching integrated with selective Broadcast, rather than, like in the prior art, using external Power Couplers, providing Switching Modules, BTB Switching Modules, and a BTB Broadcast Module for one local, shared mesh protection with bus protection loops integrated with dedicated 1+1 Dual Bus Interworking protection for protection of Bus Link failures, Bus-to-Bus Link failures, and Switching Fabrics and other equipment failures with reserved as low as 25% of protection bandwidth, rather than, like in the prior art, relying on ring protection with 50% of reserved protection bandwidth, un-protected ring-to-ring connections and expensive duplication of large Switching Fabrics, providing Add/Drop capability of the Switching Modules for creation of Virtual Private Networks (VPN) isolated by the VPN Boundary Nodes for data-security and bandwidth re-use by other VPN networks.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an example of LAN/MAN/WAN networking with the invented process of all-optical multi-bus networking.

FIG. 2 is an example of networking of three parallel buses with the BTB Links and the different ways Gateways or Terminal Equipments are connected to the buses.

FIG. 3 is an example of the method of open multi-bus networking with three parallel buses connected by the BTB Links for the BTB service routing and its protection with the bus protection loops integrated with the dedicated 1+1 DBI protection.

FIG. 4 is an example of the method of closed multi-bus networking with three parallel buses connected by the BTB Links for shared mesh protection and BTB service routing.

FIG. 5 is an example of networking and protection of three parallel buses through other, intersecting them parallel buses.

FIG. 6 shows the method of Adding or Appending DWDM signals to one WDM channel and Dropping or Drop-Continuing a plurality of DWDM signals by the three types of the Bus Interface Nodes.

FIG. 7 shows preferred embodiment of the PBIN Node design used to Append/Drop-Continue a plurality of DWDM signals to/from a WDM channel in both bus directions.

FIG. 8 shows in view A the prior art design of the DWDM HUB used to wavelength-convert and optically multiplex/demultiplex DWDM signals to/from one transmission fiber, and in view B the prior art design of a module with a plurality of the DWDM HUBs.

FIG. 9 shows in view A preferred embodiment of the FBIN Node used to Append one WDM or DWDM signal in both bus directions and to Drop one WDM or DWDM signal from a selected bus direction,

FIG. 10 shows preferred embodiment of the Interfaces of the SBIN Node.

FIG. 11 shows the many ways the SBIN Node switches and selectively broadcasts WDM channels.

FIG. 12 shows preferred embodiment of the Transmit/Receive Interface of the SBIN Node.

FIG. 13 shows the invented preferred embodiment of the BTB Broadcast Module for broadcasting WDM channels arriving at the BTB input terminals,

FIG. 14 shows in view A the invented preferred embodiment of the BTB Switch and in view B the invented preferred embodiment of its BTB Switching Module,

FIG. 15 shows in view A the invented preferred embodiment of the SBIN Switch and in view B the invented preferred embodiment of its Switching Module.

### DETAILED DESCRIPTION OF THE PREFFERED EMBODIMENTS

Detailed descriptions of the prior art preferred embodiments and the invented preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

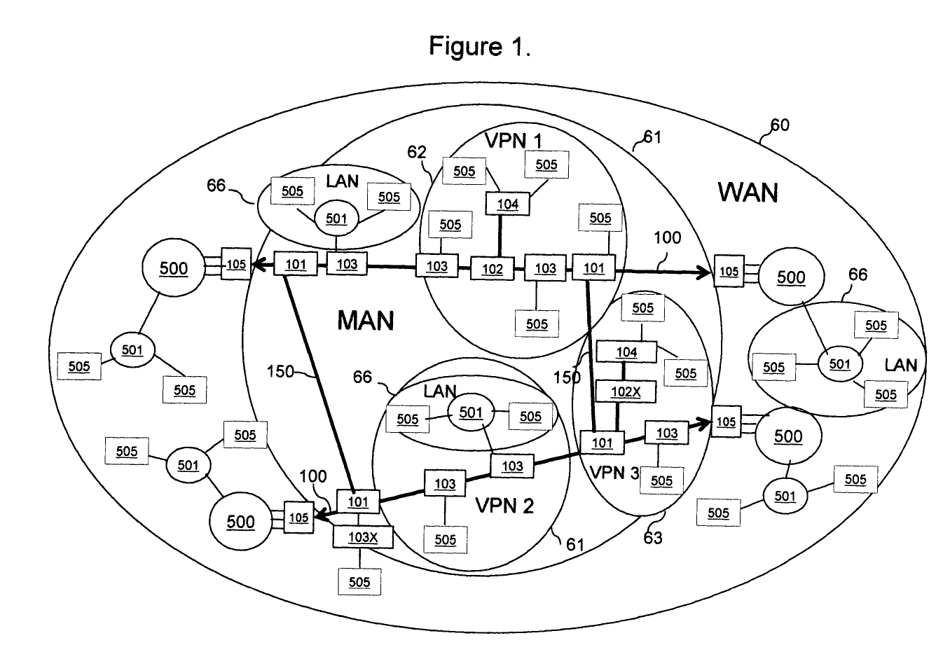

Turning now to the drawings, FIG. 1 shows an example of networking of Local (LAN), Metro (MAN) and Wide (WAN) Area Networks with the invented process of all-optical multi-bus networking for the method of mesh protected Point-To-Point, Point-To-Multipoint and Broadcast Access and Metro networking. On FIG. 1, pluralities of the prior art Terminal Equipments 505 in the LAN networks 66 are connected to the plurality of Terminal Equipments 505 in the WAN network 60 through the prior art Points Of Access (POA) 501 connected to the prior art Points Of Presence (POP) Gateways 500 to the Long Haul Networks. The POA Interfaces 501 are SONET/SDH Add/Drop Multiplexers that Time Division Multiplex/Demultiplex (TDM) individual customer signals to/from high bit-rate DWDM signals. In accordance with the invention the POP Gateways are networked by two two-fiber bidirectional buses 100. The buses are connected to each other by the BTB Links 150 for BTB service and protection routing. In the present form of the invention the buses have four types of bus interface nodes: the invented preferred embodiment of the Switching Bus Interface Node (SBIN) 101, the preferred embodiment of the Passive Bus Interface Node (PBIN) 102, the preferred embodiment of the Flexible Bus Interface Node (FBIN) 103, and the prior art DWDM Multiplex/Demultiplex Node (DWDM HUB) 105. The PBIN Node 102 Appends/Drop-Continues a plurality of DWDM signals to/from one WDM channel, possibly, already with other DWDM signals at non overlapping carrier frequencies for in-service DWDM capacity expansion of the deployed WDM systems. The DWDM HUB Node 104 connected to the PBIN Node 102 performs wavelength conversion and optical multiplexing/demultipexing of the said DWDM signals to/from one WDM channel. A plurality of the DWDM HUB Nodes 105 terminate open buses 100. The FBIN Node 103 Appends/Drop-Continues one WDM signal to/from one WDM channel, or one DWDM signal to/from one WDM channel, possibly, already with other DWDM signals at the non overlapping carrier frequencies. The SBIN Node 101 is equipped with a plurality of the FBIN Interfaces 103X to individually Add/Drop or Append/Drop-Continue one selected WDM or DWDM signal to/from one WDM channel, and with a plurality of the PBIN Interfaces 102X and/or corresponding plurality of the DWDM HUB Nodes 104 to individually Add/Drop or Append/Drop-Continue entire WDM channels with pluralities of DWDM signals. Each SBIN Node 101 terminates two, two-fiber, bidirectional BTB Links designed for BTB protection routing and BTB service routing. Each data-secure Virtual Private Network (VPN) 61, 62, 63 is provisioned with one DWDM-expanded WDM channel connecting the VPN's Terminal Equipments and terminated by two VPN SBIN Boundary Nodes to assure data-security and re-use of the bandwidth by other VPNs.

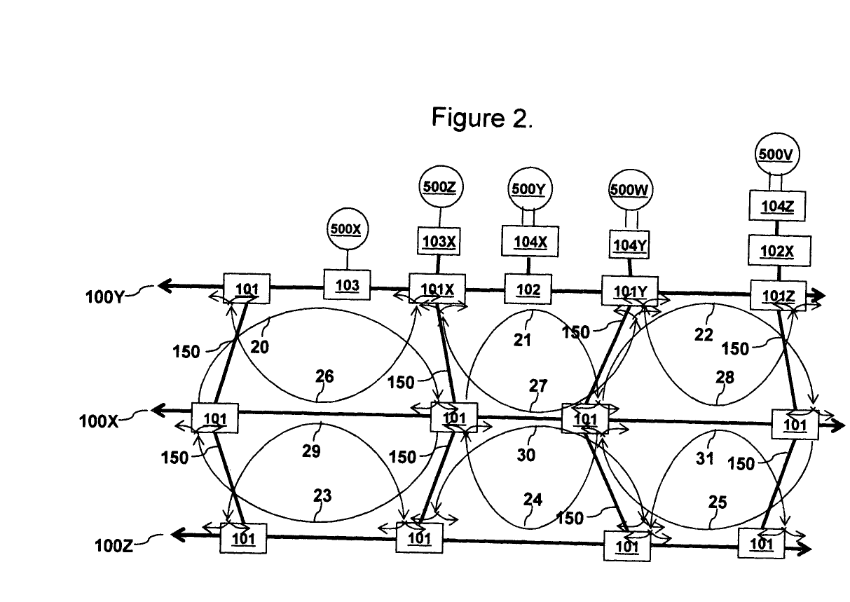

FIG. 2 illustrates shared, mesh protection of parallel buses 100X,100Y,100Z connected by the BTB Links 150, and the more ways the POP Gateways 500X,500Y,500Z,500W,500V are connected to the buses. The FBIN Node 103 interfaces a single-wavelength Gateway 505X. The PBIN Node 102 jointly with the DWDM HUB Node 104X interface a multi-wavelength Gateway 505Y. The SBIN Node 101X interfaces a single-wavelength Gateway 500Z through the FBIN Interface 103X. The SBIN Node 101Y interfaces a multi-wavelength Gateway 500W with the access to one bus direction only through the DWDM HUB Node 104Y. The SBIN Node 101Z interfaces a multi-wavelength Gateway 500V with the access to both bus directions through the PBIN Interface 102X and the DWDM HUB Node 104Z. In general any other than the POP Gateways type of single-wavelength or multi-wavelength Terminal Equipments is connected the same way as the Gateways. In accordance with the invention the format and bit-rate transparent PBIN, DWDM HUB, FBIN and SBIN Node designs are all-optical designs with Opto-Electro-Optical (OEO) regeneration, reshaping and retiming (3R) and wavelength conversion performed by the Add/Drop and the Append/Drop-Continue interfaces only.

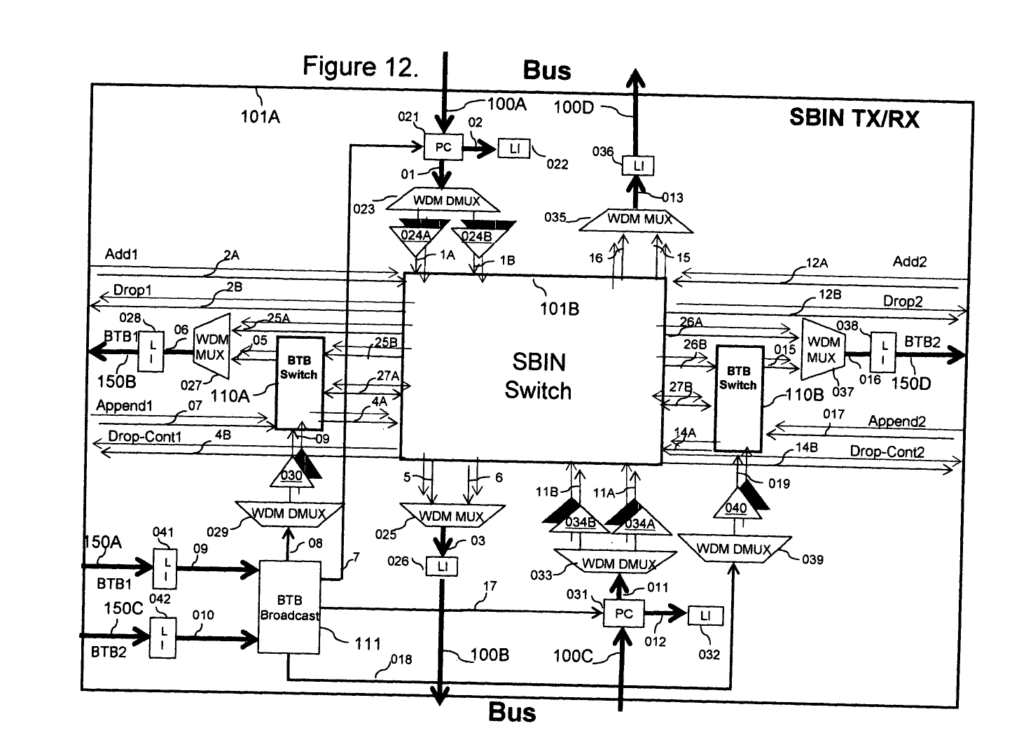

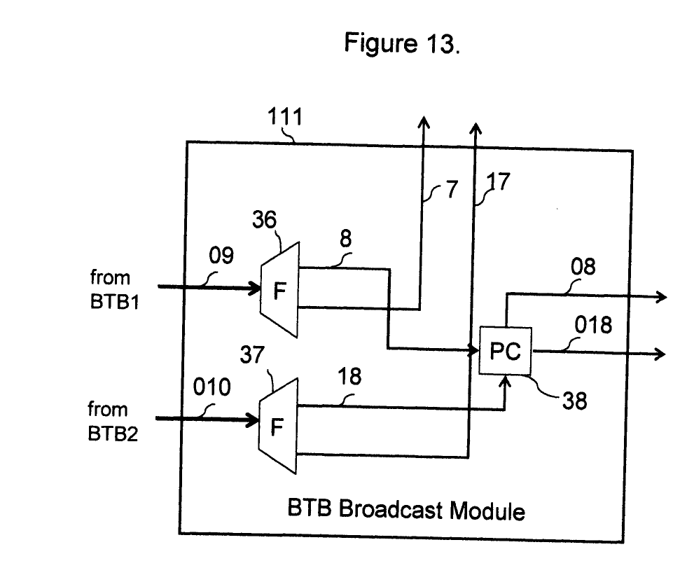

On FIG. 2 the first direction of the inner bus 100X is protected by three unidirectional bus protection loops 20,21,22 through the edge bus 100Y, and the second direction by three unidirectional bus protection loops 23,24,25 through the edge bus 100Z. Both directions of the buses 100Y and 100Z are share-protected by the bus 100X. The bidirectional bus protection loops 26,27,28 protect the edge bus 100Y and the bidirectional bus protection loops 29,30,31 protect the edge bus 100Z. It is important to notice that as shown on FIG. 2 all bus protection loops can broadcast WDM channels in both bus directions, with the option to as well broadcast them to both BTB Links (not shown). Such broadcast assures protection of not only Point-To-Point but as well Point-To-Multipoint and Broadcast connections, and protection of DWDM signals Appended/Drop-Continued by the non-protecting, pass-through PBIN 103, and FBIN 102 Nodes and of signals Added/Dropped or Appended/Drop-Continued by pass-through SBIN Nodes (not shown on FIG. 2). The shared, mesh protection loops on FIG. 2 are non-blocking with reserved 25% of transmission bandwidth of the edge buses 100Y,100Z and 50% of the inner bus 100X. Neighbor buses protecting each others failures must reserve complementary transmission bandwidths for protection; the remaining un-reserved bandwidth is used for service routing. The first preferred method of reserving protection bandwidth is partitioning Bus and BTB transmission bandwidth to two: service and protection bandwidths, the lower half-band called a B-Half-Band and the higher half-band a G-Half-Band. The second preferred method is to partition Bus and BTB transmission bandwidth to the bandwidth of all even WDM channels as well called a B-Half-Band, and the complementary bandwidth of all odd WDM channels as well called a G-Half-Band. These two or any other preferred partitioning of the transmission bandwidth impacts solely connections in the Transmit/Receive Transmission Interfaces 101A of the SBIN Node shown on FIG. 12, and design of the optical sub-band filters 36,37 in the invented preferred embodiment of the BTB Broadcast Module 111 shown on FIG. 13. The subband filters are used to separate the B-Half-Band and the G-Half-Band bandwidths from one to two fibers. For example, on FIG. 2, bus 100X could reserve the B-Half-Bands in both bus directions, bus 100Y the G-Half-Band in one bus direction and bus 100Z a G-Half-Band in the opposite to it bus direction for protection. It is important to notice that the remaining unreserved G-Half-Band bandwidths in the opposite directions of the edge buses 100Y and 100Z could be used for bidirectional service routing of the G-Half-Band WDM channels protected by the bus protection loops in the reserved G-Half-Bands of the same buses 100Y,100Z (not shown on FIG. 2) through the back-to-back BTB Link connections crossing bus 100X.

Buses with reserved G-Half-Bands are called G-Buses and buses with reserved B-Half-Bands B-Buses. SBIN Nodes on G-Buses are called G-SBIN Nodes and on the B-Buses B-SBIN Nodes. Transmission Interfaces of the G-SBIN Nodes are designed to Add/Drop both G-Half-Band WDM channels, called G-WDM channels and B-Half-Band WDM channels, called B-WDM channels, and to Append/Drop-Continue G-WDM channels only. Transmission Interfaces of the B-SBIN Nodes are designed to Add/Drop both G-WDM channels and B-WDM channels and to Append/Drop-Continue B-WDM channels only. G-WDM channels in the G-SBIN Nodes and B-WDM channels in the B-SBIN Nodes are called simply WDM service channels. G-WDM channels in the B-SBIN Nodes and B-WDM channels in the G-SBIN Nodes are called WDM protection channels. When no distinction is necessary both types of channels are called just WDM channels. Mesh protection of multi-bus networks requires that every B-Bus must be directly connected through the BTB Links to at least one G-Bus and every G-Bus to at least one B-Bus.

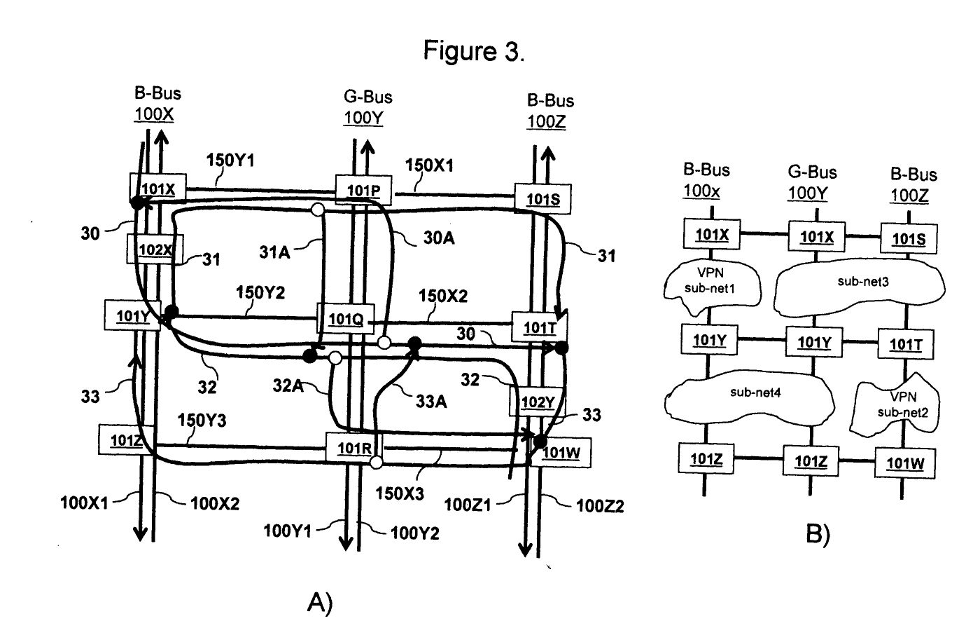

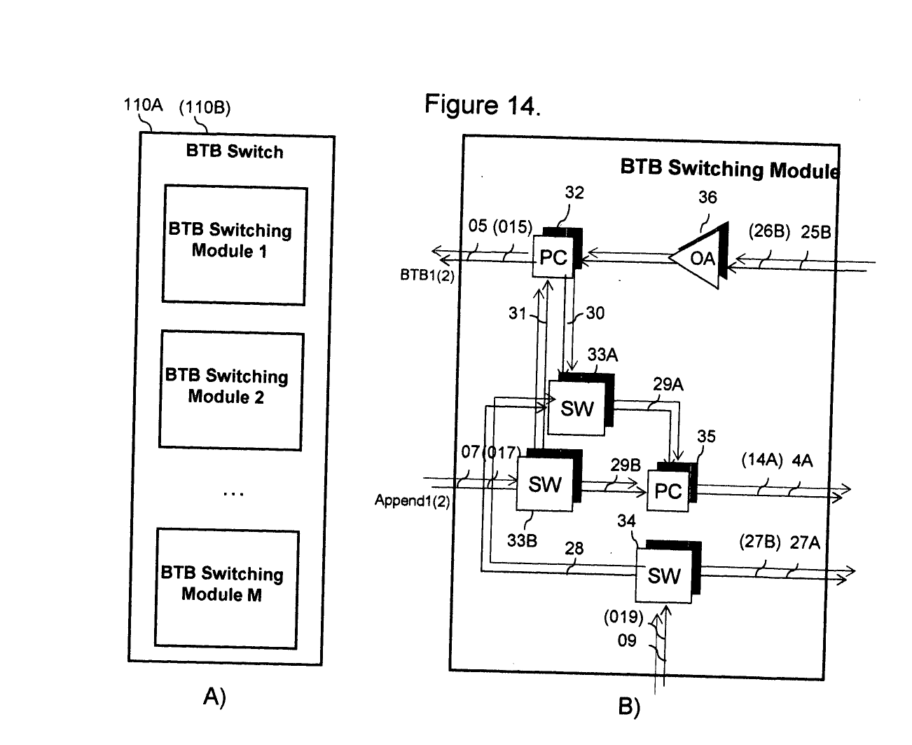

In contrast to the one dimensional SONET/SDH ring networking multi-bus networking allows plurality of networking dimensions with the BTB service routing between G-Buses crossing the in-between B-Buses or between B-Buses crossing the in-between G-Buses. The BTB service routing must be protected against both Bus Link and BTB Link failures. This is achieved with the shared bus protection loops integrated with the dedicated 1+1 Dual Bus Interworking (DBI) protection shown on FIG. 3. The design relies on the following capabilities of the invented preferred embodiments of the SBIN Nodes: 1) switching between the BTB-Drop only and the BTB-Drop-Continue modes of the SBIN Node, 2) Merging of the same bandwidth working WDM channel arriving at the Bus input terminal with the corresponding stand-by WDM channel arriving at the fix-paired with it BTB input terminal while in the 1+1 DBI protection BTB-Drop-Continue mode. Fix-pairing of the BTB and the Bus output terminals gives a simpler design of the invented preferred embodiment of the two identical BTB Switches 110A, 110B shown on FIG. 14, rather than one, more complex and expensive BTB Switch design capable of the BTB-Drop-Continue pairing of any Bus terminal with any BTB terminal. The fix-paired BTB-Drop-Continue does not restrict the functions of the shared bus protection loops integrated with the dedicated 1+1 DBI protection as long as the multi-bus network satisfies the requirement that each bus protection loop shell have each of its two BTB Links fix-paired with Bus terminals in two different bus directions, for example, on FIG. 3A the integrated protection loops through the pairs of BTB Links 150Y1,150Y2 are fixed-paired with the corresponding Bus Links 100Y1,100Y2 and the integrated protection loops through the pairs of BTB Links 150X2,150X3 are fixed-paired0 with the corresponding Bus Links 100Y1,100Y2. Since each SBIN Node fix-pairs the BTB-Links it terminates with different Bus Links one has as well that on FIG. 3A the BTB Links 150X1,150X2 are fix-paired with the Bus Links 100Y2,100Y and BTB Links 150Y2,150Y3 with the Bus Links 100Y2,100Y1. On FIG. 3A the B-SBINs 101X,101Y and the PBIN 102X on the B-Bus 100X, and the B-SBINs 101T,101W and the PBIN 102Y on the B-Bus 100Z connect Terminal Equipments in one VPN network with one DWDM-expanded bidirectional B-WDM channel. The channel is constructed by concatenating one bidirectional B-WDM channel 30,31 on the B-Bus 100X with the same bandwidth bidirectional B-WDM channel 32,33 on the B-Bus 100Z. The concatenation links are the back-to-back BTB Links through the G-SBINs 101P,101Q,101R on the G-Bus 100Y. The B-SBIN 101X and the B-SBIN 101W are the VPN Boundary Nodes where the B-WDM channel is Added/Dropped rather than Appended/Drop-Continued DWDM signals to enable re-use of its bandwidth by other downstream/upstream VPNs, and for data-security. The two unidirectional B-WDM channels 30 and 31 both carry the same DWDM signals Added/Appended by the B-SBINs 101X,101Y and by the PBIN 102X in both bus directions 100X1,100X2. The B-WDM working channel 30 is BTB-routed through the G-SBIN 101Q to the B-SBIN 101T where it becomes channel 33 routed through the PBIN 102Y to the B-SBIN 101W. The corresponding B-WDM protection channel 31 is BTB-routed through the G-SBIN 101P to the B-SBIN 101T where it remains not cross-connected as the 1+1 DBI protection B-WDM standby channel. The two unidirectional B-WDM channels 32 and 33 both carry the same DWDM signals Added/Appended by the B-SBINs 101T,101W and by the PBIN 102Y in both bus directions 100Z1, 100Z2. The B-WDM working channel 32 is BTB-routed through the G-SBIN 101Q to the B-SBIN 101Y where it becomes channel 31 routed through the PBIN 102X to the B-SBIN 101X. The corresponding B-WDM protection channel 33 is BTB-routed through the G-SBIN 101R to the B-SBIN 101Y where it remains not cross-connected as the 1+1 DBI protection B-WDM standby channel. As a general rule any BTB routing between two B-Buses crossing the in-between G-Bus should use back-to-back BTB Links cross-connected by the B-SBIN Node on the crossed G-Bus, to avoid BTB-routing in the not-protected, reserved protection bandwidth on the crossed G-Bus. And correspondingly as a general rule any BTB routing between two G-Buses crossing the in-between B-Bus should use back-to-back BTB Links cross-connected by the G-SBIN Node on the crossed B-Bus, to avoid BTB-routing in the not-protected, reserved protection bandwidth on the crossed B-Bus.

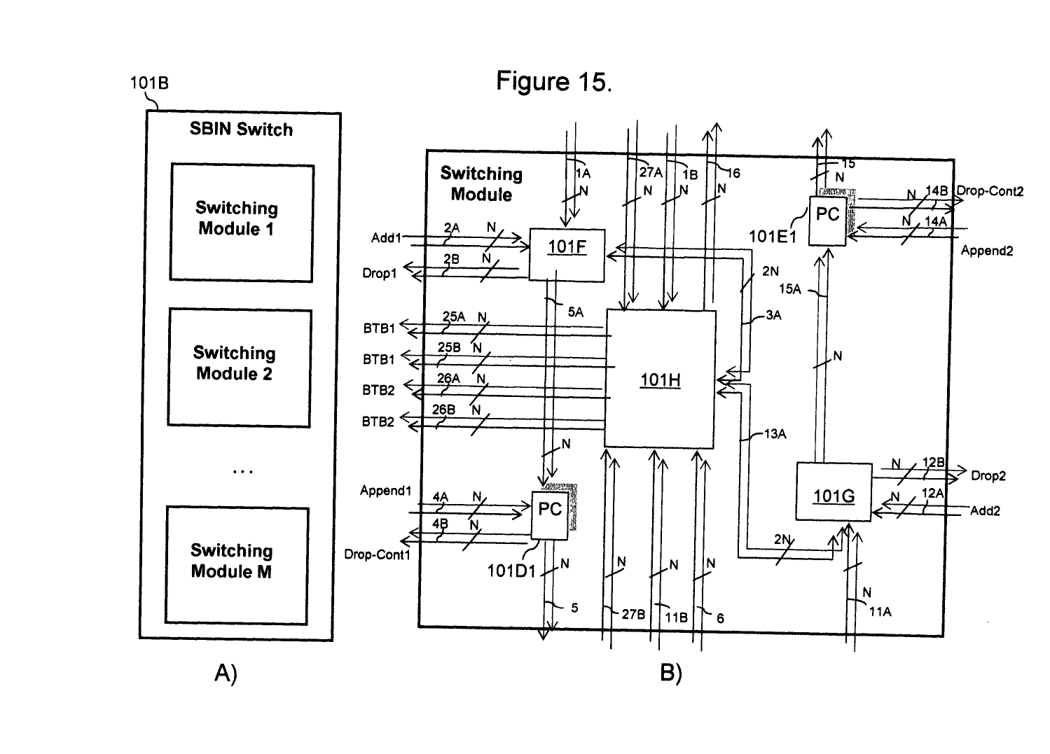

In the normal mode of operation: 1) the G-SBIN 101P BTB-Drops the B-WDM channel 31 to the BTB Link 150X1 with no Continue to the Bus Link 31A, 2) the G-SBIN 101Q BTB-Drops the B-WDM channel 30 to the BTB Link 150X2 with no Continue to the Bus Link 30A, 3) the G-SBIN 101Q BTB-Drops the B-WDM channel 32 to the BTB Link 150Y2 with no Continue to the Bus Link t32A, 4) the G-SBIN 101R BTB-Drops the B-WDM channel 33 to the BTB Link 150Y3 with no Continue to the Bus Link 33A. A LOP failure of the back-to-back BTB working connection 150Y2-150X2 is detected by both B-SBIN 101Y and B-SBIN 101T that execute the protection cross-connects of the corresponding protection, B-WDM standby channels 33, 31 and therefore Merging them with the corresponding LOP-failed and thus not there at the time of failure B-WDM channels 32, 30. An LOP failure of the B-Bus Link 101X-102X or of the Switch Fabrics or other equipment failures of the B-SBINs 101X or 101Y is protected by the bus protection loops integrated with the 1+1 DBI protection links 31, 33, through the SBINs 101P, 101Q and the Bus Links 30A, 31A. The LOP failure is detected by both B-SBIN 101X and B-SBIN 101Y that signal G-SBIN 101P and G-SBIN 101Q to switch to the BTB-Drop-Continue mode to tap-off a fixed percent of optical power from the standby B-WDM channel 31 to the Bus Link 31A on the G-Bus 100Y1, and from the working B-WDM channel 30 to the Bus Link 30A on the G-Bus 100Y2. The DWDM signals in the loop-back Bus Links 30A and 31A re-establish local connectivity between B-Bus nodes 101X,102X,101Y isolated from each other by the failure. As a result of the failure some of the BTB-routed DWDM signals are being carried to the VPN nodes on the B-Bus 100Z by the working B-WDM channel 30 while others by the standby B-WDM channel 31 and so the B-SBIN 101T must be signaled to execute the 1+1 DBI protection switch to Merge the B-WDM standby channel 31 with the B-WDM working channel 30 to reconnect the B-Bus 100X nodes 101X,102X,101Y with the B-Bus 100Z nodes 1001T,102Y,101W. The analogous protection switch is performed to protect failures of the B-Bus Links 101T-102Y and 102Y-100W and the Switch Fabrics or other equipment failures of the SBINs 101T and 101W. The exemplary VPN network on FIG. 3A has only one PBIN Node 102X on the B-Bus 100X and one PBIN Node 102Y on the B-Bus 100Z. In general the bus protection loops integrated with the 1+1 DBI protection shown on FIG. 3A could protect larger VPN sub-net1 and sub-net2 through the pass-through multi-bus sub-net3 and sub-net4 as shown on FIG. 3B. In this case the bus protection loop bus connections 30A, 31A, 32A, 33A on G-Bus 100Y are routed through the intermediate G-SBIN Nodes in the sub-net3 and sub-net4 (not shown) which is allowed by the invented preferred embodiment of the SBIN Switch 101B shown on FIG. 15 cross-connecting any one in the plurality of the SBIN Switch 101B input terminals 1B (11B) to the corresponding one in the plurality of the SBIN Switch 101B output terminals 6 (16) for the local bus routing in the reserved protection bandwidth.

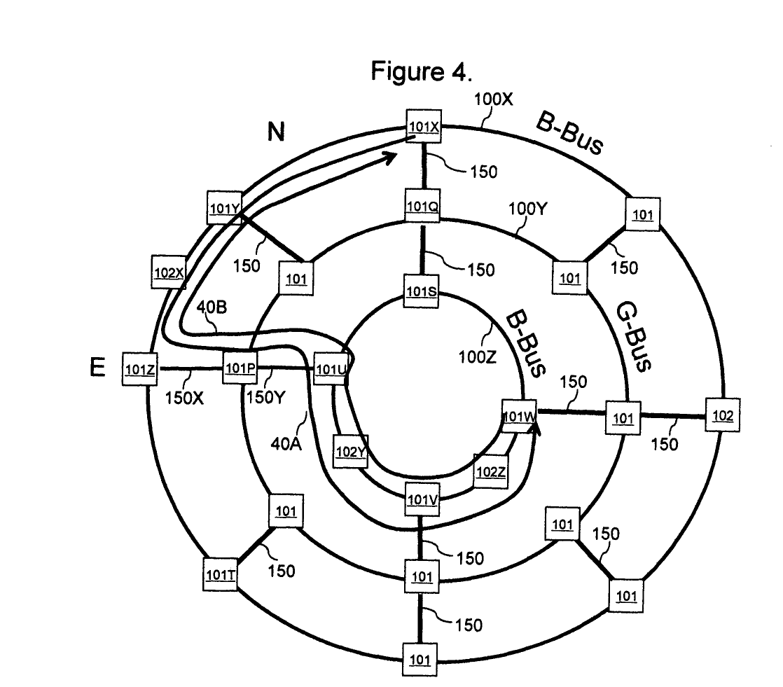

FIGS. 2,3 could represent a complete multi-bus network of parallel (not-intersecting) open buses or just sections of closed buses in a multi-layer, multi-bus ring network similar to the one shown on FIG. 4 where the closed B-Bus 100X, G-Bus 100Y, and B-Bus 100Z are connected through the BTB Links 150. On FIG. 4 the exemplary VPN network on two B-Bus rings 100X,100Z is spanned between two VPN SBIN Boundary Nodes 101X,101W. The VPN is provisioned a two-fiber, DWDM-expanded bidirectional B-WDM service channel 40A,40B with at least one DWDM signal Added/Dropped by each SBIN Boundary Node 101X,101W and Appended/Drop-Continued more DWDM signals by the nodes: 101Y,102X,101Z,101U,102Y,101V,102Z. The B-WDM service channel is BTB-routed through the back-to-back BTB Links 150X,150Y cross-connected by the pass-through G-SBIN 101P. A design of the B-WDM service channel 40A,40B bus protection loops integrated with the 1+1 DBI protection follows the same process as outlined on FIG. 3. The multi-layer ring design is expanded with a still larger G-Bus ring (not shown) added to encircle the edge B-Bus ring 100X for longer reach networking.

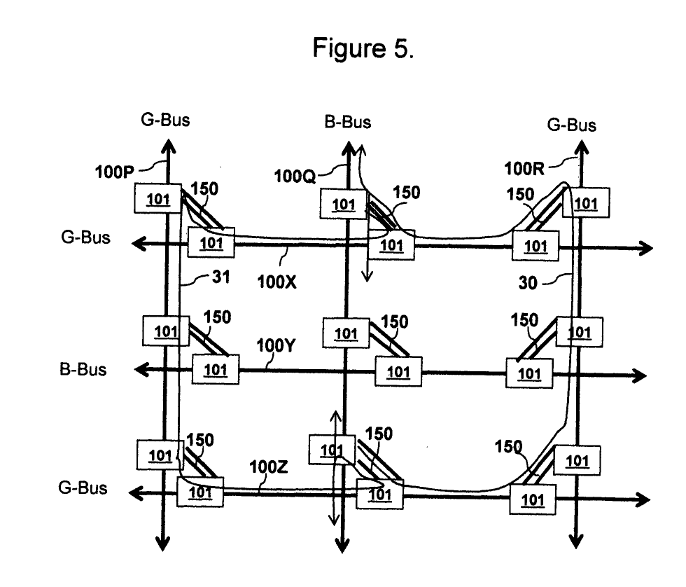

As more parallel multi-bus networks is deployed more and more often they begin intersecting each other creating the opportunity for setting-up bus protection loops through the intersecting buses using short intra-office BTB Links connecting co-located SBIN Nodes on those buses, rather than through the long BTB Links between the parallel buses. On FIG. 5 a complete multi-bus network of intersecting, open buses or just a section of a network of intersecting, closed buses has the horizontal buses 100X,100Y,100Z connected to the vertical buses 100P,100Q,100R through the intra-office, duplex, two-fiber BTB Links 150. On FIG. 5 the exemplary bidirectional bus protection loops 30,31 are provisioned in the reserved B-Half-Band protection bandwidth of the G-Buses. The loop 30 is provisioned through the G-Buses 100X,100R,100Z and the loop 31 through the G-Buses 100X,100P,100Z to protect fiber cuts of the B-Bus 100Q. It is important to notice that on FIG. 5 the protecting SBIN Nodes in some bus protection loops are just pass-through nodes in other bus protection loops. In the intersecting-buses multi-bus topologies having duplex BTB Links makes void the fixed-pairing BTB-Drop-Continue constraint described on FIG. 3.

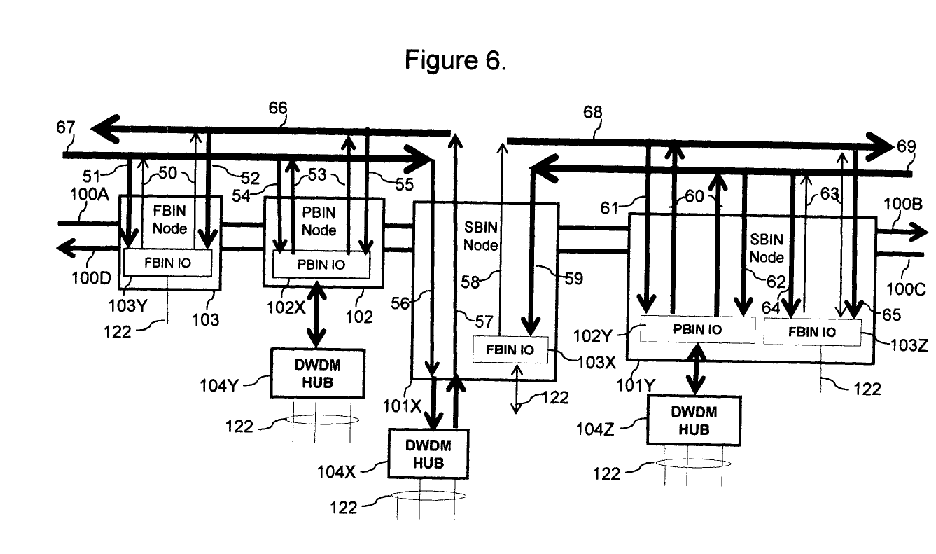

WDM multi-bus networks are capacity-expanded by Appending more DWDM signals by plurality of the PBIN, FBIN and SBIN Nodes as shown on FIG. 6 where the SBIN 101X is a Boundary Node between two VPN networks each spanned by one of the two, the same bandwidth, two-fiber, bidirectional WDM service channels 66,67 and 68,69. The WDM service channel 66,67 is created/terminated by Adding/Dropping a plurality of bidirectional DWDM signals 122 optically multiplexed/demultiplexed 56,57 by the DWDM HUB 104X, and the WDM service channel 68,69 is created/terminated by Adding 58 and Dropping 59 one bidirectional DWDM signal 122 through the FBIN Interface 103X. In the FBIN 103, the WDM channel 66,67 is Appended 50 in both bus directions and Dropped 51,52 from both bus directions one bidirectional DWDM signal 122 through the FBIN Interface 103Y. In the PBIN 102, the WDM service channel 66,67 is Appended 53 in both bus directions and Dropped 54,55 from both bus directions a plurality of bidirectional DWDM signals 122, optically multiplexed/demultiplexed to/from the WDM service channel by the DWDM HUB 104Y through the PBIN Interface 102X. In the SBIN 101Y the WDM service channel 68,69 is Appended 60 in both bus directions and Dropped 61,62 from both bus directions a plurality of the bidirectional DWDM signals 122, optically multiplexed/demultiplexed to/from the WDM service channel by the DWDM HUB 104Z through the PBIN Interface 102Y. In the SBIN 101Y, the WDM service channel 68,69 is Appended 63 in both bus directions and Dropped 64,65 from both bus directions one bidirectional DWDM signal 122 through the FBIN Interface 103Z.

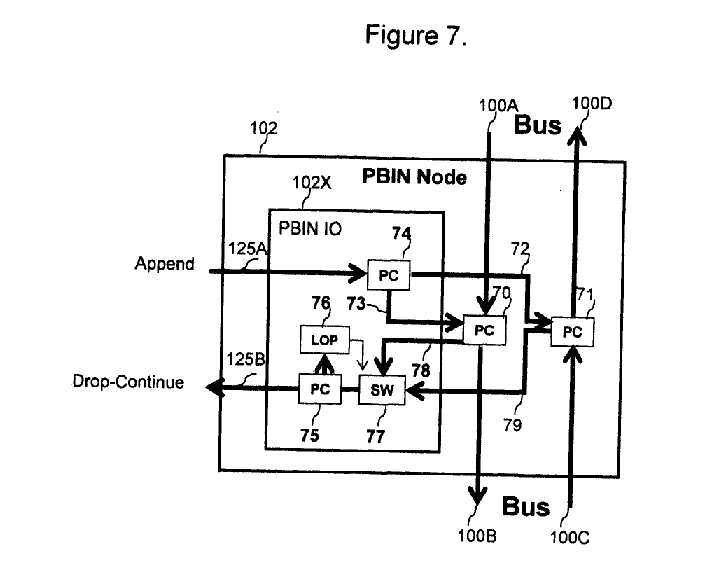

A two-fiber bidirectional ring protection of Point-To-Multipoint connections was presented at the Optical Fiber Conference (OFC) 2003 in the paper “40 km Passive Optical Metro-Access Ring (POMAR) Including a Protection Scheme Based on Bi-Directional Fibers” by F. Dorgeuille, and L. Noirie from Alcatel Research and Innovation, and by A. Bisson from Alcatel CIT. In the presented dedicated 1+1 protection method a two-fiber access ring with one HUB and 4 Access Nodes uses one fiber for a ring broadcast from the HUB in both ring directions and another for switched transmission from the Access Nodes to the HUB in one ring direction only. Each Access Node is assigned a unique wavelength. FIG. 7 shows the preferred embodiment of the Passive Bus Interface Node (PBIN Node) 102 with Power Couplers 70,71 used to Append a plurality of the DWDM optical signals 125A to one WDM channel in both bus directions 100B, 100D and to optically select one from the two bus directions 100A, 100B and to optically Drop a fixed percent of optical power of all signals from it and to optically Continue the remaining power to the fix-paired with them corresponding Bus output terminals 100B, 100D. Two Power Couplers 70,71 Append a plurality of the DWDM signals 125A power-split 72,73 by the Power Coupler 74 and routed to the Power Couplers 70,71. Power Couplers 70,71 Drop-Continue DWDM signals 78,79 from both bus directions to the Switch 77 that selects one of them 125B. The Power Coupler 75 couples off small percent of the power 125B to the LOP Detector 76. When the LOP Detector 76 detects the LOP of the signals Dropped from the selected Bus input terminal 100A or 100C it controls Switch 77 to select the stand-by WDM channel from the not-selected, standby bus input terminal 100C or 100A.

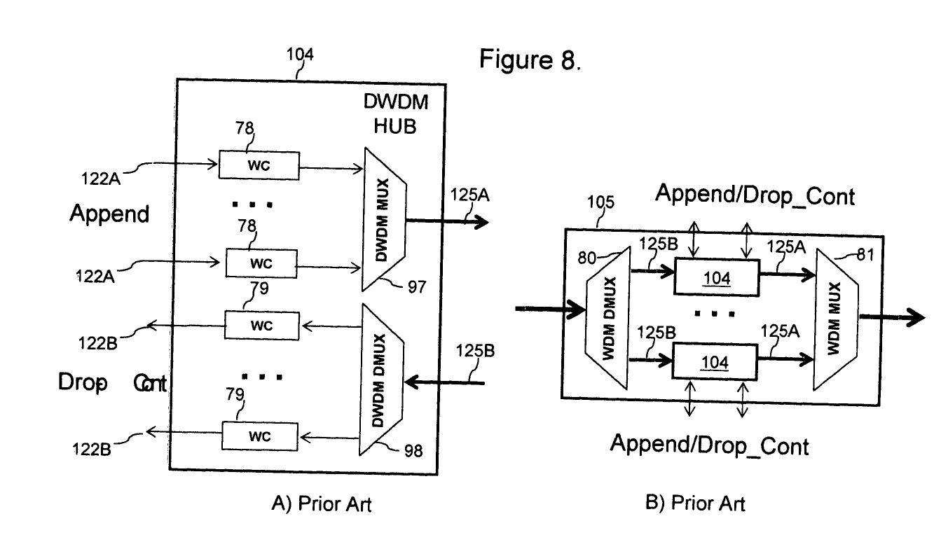

The PBIN Node is used to Append/Drop-Continue DWDM signals to/from both bus directions. It is connected to the prior art DWDM HUB Node 104, shown on FIG. 8A, used to wavelength convert 78 the Appended short reach optics signals 122A to the DWDM signals and to optically multiplex them 97 to one WDM channel 125A. The DWDM HUB 104 wavelength converts 79 to the short reach optics optically demultiplexed 98 DWDM signals 122B Dropped from the WDM channel 125B. As shown on FIG. 8B a plurality of the prior art DWDM HUBs 104 is interfaced by the prior art optical WDM multiplexer 81 and optical WDM demultiplexer 80 to interface all WDM channels in the two bus fibers. For example 20 nm Course WDM channels (CWDM) with 1600 GHz pass-bands multiplexed/demultiplexed by the WDM MUX/DMUX 023,033,025,035,027,037,029,039 on FIG. 12 allow the maximum number of the DWDM signals in each WDM channel as given in Table in Appendix A, which as well includes maximum bit-rate of the DWDM signals and the corresponding WDM channel capacity.

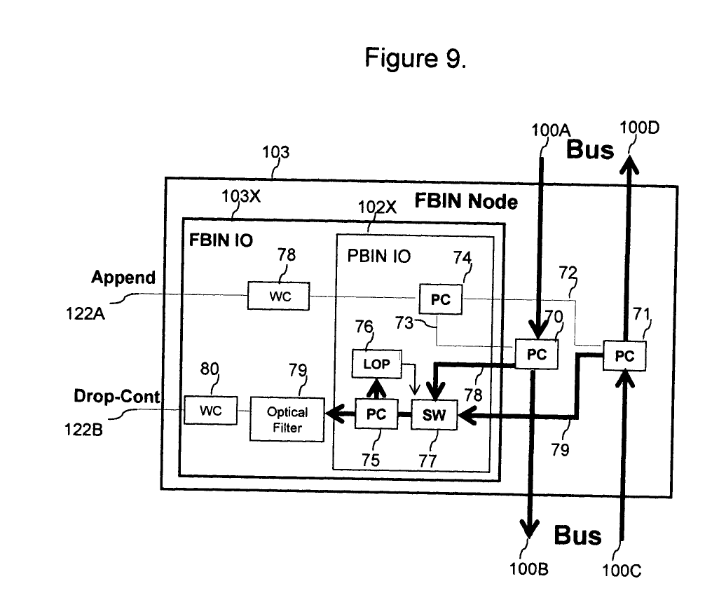

To flexibly Append/Drop-Continue just one DWDM signal to/from one WDM channel in both bus directions one has the preferred embodiment of the Flexible Bus Interface Node (FBIN) 103, shown on FIG. 9A. The FBIN Node has the FBIN Interface 103X that includes the PBIN Interface 102X described on FIG. 7B, plus an optionally tunable, Wavelength Converter 78 to wavelength convert the short reach optics input signal to the DWDM signal at the selected idle carrier frequency, and a tunable Optical Filter 79 to select one DWDM signal from all Drop-Continued DWDM signals and to wavelength convert it 80 to the short reach optics signal 122B. The range of tunability of the wavelength converter 78 and of the optical filter 79 decides whether the bidirectional DWDM signal could be selected from just one WDM channel or from many WDM channels.

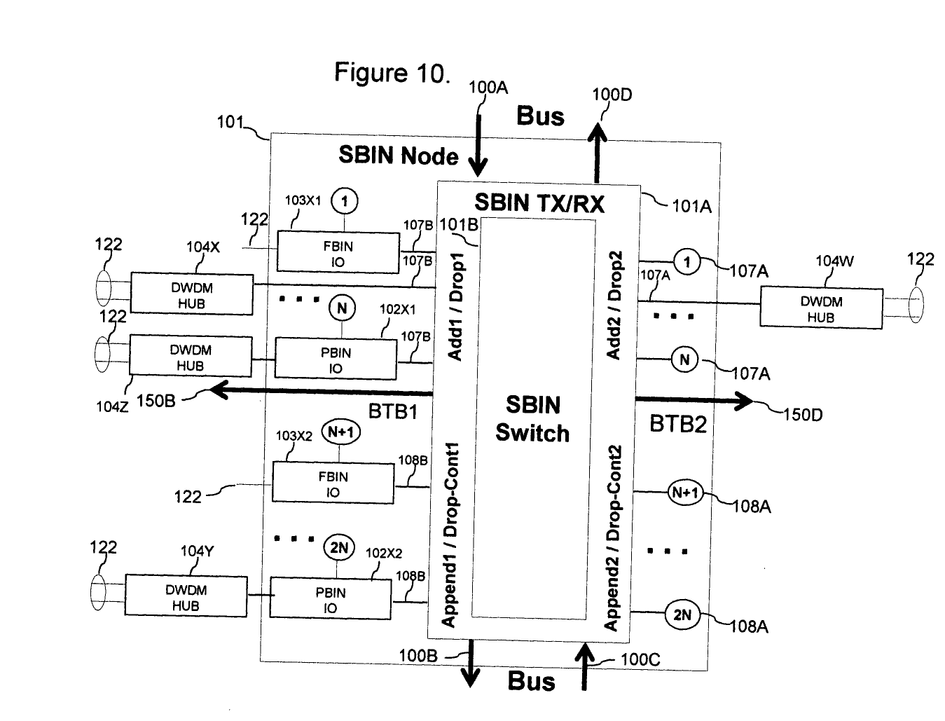

To the best of author's knowledge no prior art exists regarding an all-optical switch with the optical wavelength switching capability integrated with the selective broadcast capability. The invented preferred embodiment of the Switching Bus Interface Node (SBIN) both switches and broadcasts WDM channels to/from the Bus Links and the BTB Links, including a plurality or the DWDM signals Added or Appended by it to those channels. Each SBIN Node terminates two BTB Links designed for protection of the bus fiber-cuts and SBIN Node Switch Fabrics and other equipment failures. The links are as well used for BTB service routing. Non-blocking of service by protection is achieved by reserving as low as 25% of protection bandwidth. The BTB Links are used primarily to connect SBIN Nodes on different buses but as well could connect SBIN Nodes on the same bus for protection of the single-bus network. A single-bus network is scalable to the multi-bus network by in-service installing BTB Links between the SBIN Nodes on the current and the expansion buses. FIG. 10 shows the interfaces and the sub-systems of the SBIN Node: 1) a plurality of the PBIN Interfaces 102X1 and a corresponding plurality of the DWDM HUB Nodes 104Z to Add/Drop pluralities of bidirectional DWDM signals 122 to/from the plurality of the pairs of the WDM channels 107A, 107B, each one in different bus direction, 2) a plurality of the PBIN Interfaces 102X2 and the corresponding DWDM HUB Nodes 104Y to Append/Drop-Continue pluralities of bidirectional DWDM signals 122 to/from a plurality of the pairs of the WDM channels 108A, 108B, each one in different bus direction, 3) a plurality of the FBIN Interfaces 103X1 to Add/Drop one DWDM signal 122 by each to/from a plurality of the pairs of the WDM channels 107A,107B, each one in different bus direction, 4) a plurality of the FBIN Interfaces 103X2 to Append/Drop-Continue one DWDM signal 122 by each to/from a plurality of the pairs of the WDM channels 108A,108B, each one in different bus direction, 5) a plurality of the prior art DWDM HUB Nodes 104X to Add/Drop plurality of the DWDM signals 122 to/from one WDM channel 107B in one bus direction 100A-to-100B, 6) a plurality of the prior art DWDM HUB Nodes 104W to Add/Drop a plurality of the DWDM signals 122 to/from one WDM channel 107A in one bus direction 100C-to-100D, 7) the SBIN Node Transmit-Receive (TX-RX) Interface 101A, and 8) the SBIN Switch 1018. It is important to notice that the plurality of the DWDM signals Added/Dropped by the plurality of the DWDM HUBs 104X,104W are Added/Dropped to/from one bus direction only in the SBIN Nodes that are the Boundary Nodes of a VPN network spanned by the DWDM-expanded WDM channel, as was shown on FIG. 6. The preferred embodiment of the identical PBIN Interfaces 102X1,102X2 was described on FIG. 7B (PBIN Interface 102X), and the preferred embodiment of the identical FBIN Interfaces 103X1,103X2 on FIG. 9B (FBIN Interface 103X).

According to FIG. 10 the SBIN Switch 101B has the following terminals: 1) a plurality of the Add1/Drop1 bidirectional terminals 107B to Add/Drop DWDM signals to/from the Bus terminals 100A,100B, 2) a plurality of the Append1/Drop-Continue1 bidirectional terminals 108B to Append/Drop-Continue DWDM signals to/from the Bus terminals 100A,100B, 3) a plurality of the Add2/Drop2 bidirectional terminals 107A to Add/Drop DWDM signals to/from the Bus terminals 100C,100D, 4) a plurality of the Append2/Drop-Continue2 bidirectional terminals 108A to Append/Drop-Continue DWDM signals to/from the Bus terminals 100C,100D, 5) one bidirectional Bus terminal 100A,100D to connect the first one of the two two-fiber bidirectional Bus Links 6) one bidirectional Bus terminal 100B,100C to connect the second one of the two-fiber bidirectional Bus Links, and 7) two unidirectional BTB Link output terminals 150B,150D. In the preferred embodiment Added/Appended signals are broadcasted in both bus directions and the received DWDM signals are Dropped/Drop-Continued from both bus directions as well Any of the plurality of the FBIN Interfaces 103X1,103X2, or any of the plurality of the PBIN Interfaces 102X1,102X2 could be connected to just one in the plurality of the pairs of the Add/Drop terminals 107A,107B, or 108A,108B to up to double the number of connected Terminals at the price of not being able to broadcast in both bus directions.

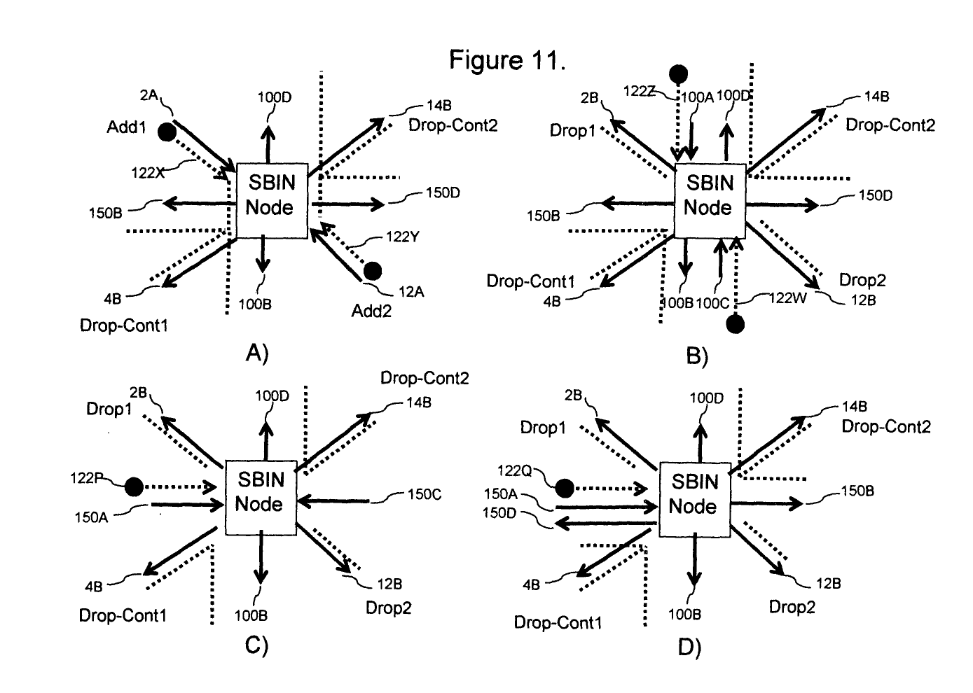

FIG. 11 summarizes the broadcasting capabilities of the SBIN Node. On FIG. 11A a one WDM signal or a plurality of DWDM signals 122X is Added to one WDM service channel by one in the plurality of the Add1 input terminals 2A or 12A and selectively broadcasted up to 3 ways. On the same figure a one WDM signal or a plurality of the DWDM signals 122Y is Apendded to one WDM service channel by one in the plurality of the Append1 4A or Append2 14A input terminals and selectively broadcasted up to 2 ways. On FIG. 11B a one WDM signal or a plurality of DWDM signals 122Z or 122W in one WDM service channel arriving at the Bus input terminal 100A or 100B is Dropped to one in the plurality of the fix-paired with it Drop1 output terminals 2B or to one in the plurality of the Drop2 output terminals 12B, or is selectively broadcasted up to 3 ways. WDM channels arriving at the BTB input terminals 150A, 150C in the same bandwidth as the SBIN Node's not reserved service bandwidth are switched and broadcasted differently than the WDM channels arriving at the same SBIN Node in the same bandwidth as its reserved protection bandwidth. Both BTB input terminals 150A and 150C are switched the same way, and so FIGS. 11C,D show only one of them for clrearity of presenation. On FIG. 11C a WDM channel arriving at the BTB input terminal 150A in the same bandwidth as the SBIN Node's protection bandwidth is switched and selectively broadcasted up to 3 ways. On FIG. 11D a WDM channel arriving at the BTB input terminal 150A in the same bandwidth as the local node's service bandwidth is switched and broadcasted up to 3 ways. Table in Appendix B gives all possible ways a given WDM channel is switched and broadcasted on FIGS. 11A-D.

The preferred embodiment of the SBIN TX-RX Transmission Interface 101A on FIG. 10 is described in detail on FIG. 12. A symmetry of design of the two Bus directions of transmission and of the two BTB directions or transmission allows discribing just one of them with the second one given in brackets. The interface 101A has the prior art Line Interface (LI) module 022 (032) on the Bus input terminal 100A (100C) and the prior art LI module 041 (042) on the BTB input terminal 150A (150C) to detect the LOP and to optionally filter out the network maintenance optical signal. The TX-RX Interface has the prior art LI module 026 (036) on the Bus output terminal 100B (100D) and the prior art LI module 028 (038) on the BTB output terminal 150B (150D) to detect the LOP to the output fibers, and to optionally insert the network maintenance optical signal, and are optionally installed 1:1 Switches to force the LOP in the outgoing not failed fiber in the bidirectional protection of unidirectional failures. A detection of the LOP by the Bus output terminal 100B (100D) is correlated with detection of the LOP by the Bus input terminal 100A (100C) and by the BTB input terminal 150A (150C) to fault isolate upstream fiber-cuts from the local Switch Fabrics failures. The TX-RX Interface has a plurality of the prior art Optical Amplifiers 024A (034A) to individually pre-amplify WDM service channels arriving at the Bus input terminal 100A (100C) and a plurality of the prior art Optical Amplifiers (OA) 024B (034B) to individually pre-amplify the WDM protection channels Merged from the Bus input terminal 100A (100C) with the WDM protection channels from the BTB input terminal 150A (150C), by the Power Coupler 021 (031). In the preferred embodiment the TX-RX Interface has a plurality of the prior art Optical Amplifiers 030 (040) to individually pre-amplify WDM channels returning from protection from the neighbor bus or BTB-routed from there and arriving at the BTB input terminal 150A (150C) in the same bandwidth as the local SBIN Node's service bandwidth. Other amplification schemes could be employed as long as they are not impairing the switching and broadcasting functions of the invented preferred embodiment of the SBIN Node. In the preferred embodiment the TX-RX Interface has the prior art WDM Demultiplexer 023 (033) to optically demultiplex a plurality of the WDM service channels and the WDM protection channels arriving at the Bus input terminal 100A (100C) to the corresponding plurality of the connections 1A,1B (11A,11B), and the prior art WDM Multiplexer 025 (035) to optically multiplex a plurality of the WDM service channels in the fibers 5 (15) and WDM protection channels in the fibers 6 (16) to the Bus output terminal 100B (100D). It has the prior art WDM Multiplexer 027 (037) to optically multiplex WDM service channels in the plurality of the fibers 05 (015) and the WDM protection channels in the plurality of the fibers 25A (26A) to the BTB output terminal 150B (150D). Demultiplexing WDM channels arriving at the BTB input terminal 150A (150B) is a two stage process. In the first stage the prior art optical filter 36 (37) in the BTB Broadcast module 111 on FIG. 13 separates WDM service channels (B-WDM channels arriving at the B-SBIN Node or G-WDM channels arriving at the B-SBIN Node) from the WDM protection channels (G-WDM channels arriving at the B-SBIN Node or B-WDM channels arriving at the B-SBIN Node) to the corresponding fibers 8 and 7 (18 and 17). In the second stage the WDM service channels broadcasted by the BTB Broadcast module 111 to both fibers 08 and 018 are demultiplexed by the prior art WDM Demultiplexers 029, 039. The plurality of the WDM protection channels in the fiber 7 (17) is not demultiplexed, instead they are Merged by the Power Coupler 021 (031) with the plurality of the WDM protection channels arriving at the Bus input terminal 100A (100C). A total number of the WDM channels optically multiplexed and demultiplexed by the WDM Multiplexers and Demultiplexers depends on the specific implementation of the SBIN Node and could vary from as few as 2 to as many as 160 and more in the future systems. In the Course WDM (CWDM) system the number of the WDM channels is usually 8 or 16. It is admissable that the prior art WDM Multiplexers, WDM Demultiplexers, Line Interfaces, and Optical Amplifiers are not part of the SBIN Node design but rather a part of an external optical WDM Transmission System.

A symmetrical design of the G-SBIN and the B-SBIN Nodes enables one decription of both with the B-SBIN Node connections given in brackets. G-SBIN (B-SBIN) Nodes on the G-Buses (B-Buses) with reserved B-Half-Band (G-Half-Band) protection bandwidths are connected as follows. In the G-SBIN (B-SBIN) Node a plurality of the SBIN Switch 101B input terminals 1A is connected through the OAs 024A to the G-Half-Band (B-Half-Band) outputs of the WDM Demultipexer 023, and a plurality of the SBIN Switch 101B input terminals 1B through the OAs 024B to the B-Half-Band (G-Half-Band) outputs of the WDM Demultipexer 023. In the G-SBIN (B-SBIN) Node a plurality of the SBIN Switch 101B input terminals 11A is connected through the OAs 034A to the G-Half-Band (B-Half-Band) outputs of the WDM Demultipexer 033, and a plurality of the SBIN Switch 101B input terminals 11B is connected through the OAs 034B to the B-Half-Band (G-Half-Band) outputs of the WDM Demultipexer 033. In the G-SBIN (B-SBIN) Node a plurality of the SBIN Switch 101B output terminals 5 is connected to the G-Half-Band (B-Half-Band) inputs of the WDM Multipexer 025, and a plurality of the SBIN Switch 101B output terminals 6 to the B-Half-Band (G-Half-Band) inputs of the WDM Multipexer 025. In the G-SBIN (B-SBIN) Node a plurality of the SBIN Switch 101B output terminals 15 is connected to the G-Half-Band (B-Half-Band) inputs of the WDM Multipexer 035, and a plurality of the SBIN Switch 101B output terminals 16 to the B-Half-Band (G-Half-Band) inputs of the WDM Multipexer 035. In the G-SBIN (B-SBIN) Node a plurality of the BTB Switch 110A output terminals 05 is connected to the G-Half-Band (B-Half-Band) inputs of the WDM Multipexer 027, and a plurality of the SBIN Switch 101B output terminals 25A to the B-Half-Band (G-Half-Band) inputs of the WDM Multipexer 027. In the G-SBIN (B-SBIN) Node a plurality of the BTB Switch 110B output terminals 015 is connected to the G-Half-Band (B-Half-Band) inputs of the WDM Multipexer 037, and a plurality of the SBIN Switch 101B output terminals 26A to the B-Half-Band (G-Half-Band) inputs of the WDM Multipexer 037. In the G-SBIN (B-SBIN) Node the BTB Broadcast Module 111 input terminal 09 is connected to the BTB input terminal 150A through the LI module 041, and the the BTB Braodcast 111 input terminal 010 to the BTB input terminal 150C through the LI module 042. In the G-SBIN (B-SBIN) Node the BTB Broadcast Module 111 output terminal 08 is connected to the input of the WDM Demultiplexer 029 and the output terminal 018 to the input of the WDM Demultiplexer 039. In the G-SBIN (B-SBIN) Node the BTB Broadcast Module 111 output 7 is connected to the Power Coupler 021 and the output terminal 17 to the Power Coupler 031. In the G-SBIN (B-SBIN) Node a plurality of the BTB Switch 110A input terminals 09 is connected, through the OAs 030, to the G-Half-Band (B-Half-Band) outputs of the WDM Demultiplexer 029 and the remaining B-Half-Band (G-Half-Band) outputs are not connected, and a plurality of the BTB Switch 110B input terminals 019 is connected through the OAs 040 to the G-Half-Band (B-Half-Band) outputs of the WDM Demultiplexer 039 and the remaining B-Half-Band (G-Half-Band) output terminals are not connected.

The remaining connections of the SBIN TX-RX Interface 101A on FIG. 12 is common for both G-SBIN and B-SBIN Nodes. A symmetry of connections in the two Bus and BTB directions of transmission allows description of just one of them with the second given in brackets. The Bus input terminal 100A (100C) is connected to the Power Coupler 021 (031) that splits power of the input signals to two outputs 01,02 (011,012). Output 02 (012) is connected to the LI module 022 (032) and output 01 (011) to the input of the WDM Demultiplexer 023 (033). The second input of the Power Coupler 021 (031) is connected to the output terminal 7 (17) of the BTB Broadcast Module 111. The WDM Demultiplexer 023 (033) demultiplexes WDM channels arriving at its input 01 (011) to a plurality of the outputs connected to the plurality of the optical amplifiers 024A, 024B (034A,034B) in turn connected to the plurality of the SBIN Switch 101B input terminals 1A,1B (11A,11B). The output 03 (013) of the WDM Multiplexer 025 (035) is connected to the LI module 026 (036) in turn connected to the Bus output terminal 100B (100D). A plurality of the Add1(2) input terminals 2A, (12A) is connected to the SBIN Switch 101B. Pluralities of connections 4A (14A), 25B (26B), 27A (27B) connect SBIN Switch 101B with the BTB Switch 110A (110B). The output 06 (016) of the WDM Multiplexer 027 (037) is connected to the LI module 028 (038) in turn connected to the BTB output terminal 150B (150D). A plurality of the Append1(2) input terminals 07, (017) is connected to the BTB Switch 110A (110B). A plurality of the Drop-Cont1(2) output terminals 4B (14B) is connected to the SBIN Switch 101B. The BTB1(2) input terminal 150A (150C) is connected to the LI module 041 (042) that output 09 (010) is in turn connected to the input terminal of the BTB Broadcast Module 111.

The invented preferred embodiment of the BTB Broadcast Module 111 on FIG. 12 is shown on FIG. 13. Symmetry of design of routing of the WDM channels arriving at the BTB Broadcast Module 111 input terminals 09,010 from corresponding BTB1 input terminal 150A and BTB2 input terminal 150C allows describing just one of them with the second one given in brackets. On FIG. 13 the BTB1 (2) input terminal 09 (010) is connected to the subband filter 36 (37). The optical sub-band filter 36 (37) is designed to separate the B-Half-Band WDM channels from the G-Half-Band WDM channels from one 09 (010) to two 7,8 (17,18) fibers. In the G-SBIN Node the G-Half-Band output of the sub-band filter 36 (37) is connected to the output terminal 7 (17) and the B-Half-Band output to the output 8 (18). In the B-SBIN Node the G-Half-Band output of the sub-band filter 36 (37) is connected to the output 8 (18) and the B-Half-Band output to the output terminal 7 (17). This way the output terminal 7 (17) always routes the WDM channels re-directed for protection from the failed, neighbor bus or the BTB-routed WDM channels arriving in the same bandwidth as the local SBIN Node's protection bandwidth and Merged by the Power Coupler 021 (031) with the same bandwidth WDM channels routed from the Bus input terminal 100A (100C). This way the output 8, (18) always routes the WDM channels returning from protection from the neighbor buses or the BTB-routed WDM channels arriving in the same bandwidth as the local SBIN Node's service bandwidth. The sub-band filter outputs 8,18 are coupled by the Power Coupler 38 and power split by it to two output terminals 08, 018.

The invented preferred embodiment of the two identical BTB Switches 110A and 110B on FIG. 12 is shown on FIG. 14A. Both BTB Switches 110A, 110B have M identical BTB Switching Modules, the invented preferred embodiment of which was shown on FIG. 14B with connections in the BTB Switch 110B given in brackets. In the normal mode of operation a plurality of the DWDM signals Appended from a plurality of the Append1(2) input terminals 07 (017) on the local bus is switched by a plurality of Optical Switches 33B to outputs 29B connected to a plurality of Power Couplers 35 coupling them to a plurality of the output terminals 4A (14A). In the bus failure mode of operation the Optical Switches 33B switch the Appended DWDM signals to outputs 31 connected to a plurality of Power Couplers 32 coupling them to a plurality of output terminals 05 (015) further routed to the BTB output terminal 150B (150D). Pluralities of DWDM signals arriving at the plurality of the Append1(2) input terminals 07 (017) are Appended to the fixed-paired with them BTB output terminal 100B (100D), they are switched by a plurality of the Optical Switches 33B to outputs 31 connected to the plurality of the Power Couplers 32 coupling them to a plurality of output terminals 05 (015). In the BTB Link failure mode of operation the Optical Switches 33B switch the pluralities of the Appended DWDM signals to outputs 29B connected to a plurality of the Power Couplers 35 coupling them to the plurality of the output terminals 4A (14A) and further Appended to the 1+1 DBI protection WDM stand-by channel. It is worth mentioning that the plurality of the Optical Switches 33B used for protection and BTB-routing of the Appended DWDM signals are optional. Observing that since each Appended signal is broadcasted to both BTB Switches 110A and 110B one concludes that the fixed-pairing of the Appended input terminals 07 (017) with the BTB output terminal 150B (150D) and the Bus output terminal 100B (100D) does not create a routing constrain, since each Appended signal could be re-directed to either of the two BTB output terminals 150B or 150D as required by specific provisioning of the bus protection loops, and by the same token each Appended service signal could be BTB-routed to either of the two BTB Links. Fixed-paring of the Append/Drop-Continue terminals is another reason why the VPN Boundary Nodes that access just one bus direction use the Add/Drop terminals cross-connected for protection by the Switch Fabrics 101F,101G to the Switch Fabrics 101H on FIG. 15 that in turn cross-connect them towards either the 150B or the 150D BTB output terminal as required by specific provisioning of the bus protection loops.

On FIG. 14 WDM channels re-directed for protection from the failed neighbor buses and arriving at the plurality of the input terminals 09 (019) are switched by the plurality of the Optical Switches 34 to outputs 28 when they are Drop-Continued and/or routed through the node on the local bus, or to the plurality of the output terminals 27A (27B) when they are Dropped by the node. WDM channels switched to outputs 28 are coupled by the plurality of the Power Couplers 35 to the output terminals 4A (14A), further routed to the plurality of the Drop-Continue1 (2) output terminals 4B, (14B) and to the Bus output terminal 100B (100D) shown on FIG. 15.

A WDM channel returning from protection from the neighbor bus or a BTB-routed WDM channel Dropped by the local SBIN Node is switched by one in the plurality of the Optical Switches 34 to the output terminal 27A (27B) and it is further routed to one in the plurality of the protection Switch-Fabrics 101H in the SBIN Switch 101B on FIG. 15, cross-connecting it to one in the plurality of the outputs 3A,13A (3B,13B) connected to one in the plurality of the Switch Fabrics 101F, 101G in turn cross-connecting it to one in the plurality of the Drop output terminals 2B, (12B).

On FIG. 14 a BTB-routed WDM channel arriving from the neighbor bus and routed to one in the plurality of the input terminals 09 (019) is switched by one in the plurality of the Optical Switches 34 to output 27A (27B) and is further routed to the protection Switch Fabrics 101H on FIG. 15 cross-connecting it to one in the plurality of the output terminals 25A, 26A.

A BTB-routed WDM service channel or a WDM service channel re-directed for protection from the failed local bus is cross-connected by one of the Switch Fabrics 101F,101G to the Switch Fabrics 101H on FIG. 15 that cross-connects it to one in the plurality of the input terminals 25B (26B) connected to the BTB Switch 110A or 110B on FIG. 14, where it is amplified by one in the plurality of the Optical Amplifiers 36 connected to one in the plurality of the Power Couplers 32 power-splitting it to two outputs: 05 (015) and 30. In the normal mode of operation the BTB-routed WDM channel is BTB-Dropped to the neighbor bus. When the WDM service channel is BTB-Dropped only the corresponding one in the plurality of the Optical Switches 33A switches its input 28 to the output 29A. In the failure mode of operation the BTB-routed WDM service channel is BTB-Drop-Continued—it is switched by one in the plurality of the Optical Switches 33A to the output 29A connected to one in the plurality of the Power Coupler 35 coupling it to one in the plurality of the output terminals 4A (14A).

The invented preferred embodiment of the modular design of the SBIN Switch 101B on FIG. 12 is shown on FIG. 15A. The SBIN Switch 101B has identical Switching Modules in both G-SBIN and B-SBIN Nodes. Symmetry of design of the Switching Modules in both bus directions of bus and bus-to-bus transmission allows description of just one direction with the second one given in brackets. FIG. 15B gives the invented preferred embodiment of the Switching Module comprised of the Switch Fabrics 101F,101G,101H. An SBIN Switch is in-service expanded with as many Switching Modules as is required by the traffic demand for up to the total number of the input/output terminals of the WDM Multiplexers and Demultiplexers: 023,033,025,035,027,037,029,039 on FIG. 12. A pair of the Switch Fabrics 101F,101G switches WDM service channels only, each of them has 6N terminals, they are: 1) 2N output terminals 2B,5A (12B,15A), 2) 2N input terminals 1A,2A (11A,12A), 3) 2N terminals 3A (13A) used either as output terminals for protection or BTB-routing from the Add 2A (12A) and Bus 1A (11A) input terminals, or as input terminals for routing to the Drop output terminals 2B (12B). Obviously a switching terminal could not be an input and an output terminal at the same time since this would result in blocking and so the total number of connections in each plurality of connections 3A,3B (13A,13B) must be at least 2N, where N in the number of the Add Terminals. The service routing constraint is that the total 2N WDM channels arriving at the input terminals cannot be all routed to the N output terminals, or in other words at least one in the plurality of the Bus input terminals 1A (11A) must be first switched either to one in the plurality of the Drop output terminals 2B (12B) or to one in the plurality of the BTB-Drop output terminals 3A (13A) before a new WDM channel could be Added and cross-connected to the Bus output terminal 5A (15A). If however the WDM channel from the Add input terminal 2A (12A) is BTB-Dropped through one in the plurality of the output terminals 3A (13A), than the WDM channel in the Bus input terminal 1A (11A) could be cross-connected to the Bus output terminal 5A (15A). In the normal mode a BTB-Drop or BTB-Drop-Continue routed WDM service channel is cross-connected by the Switch Fabrics 101F or 101G to the Switch Fabrics 101H that in turn cross-connects it to one of the two: 1) one of the N BTB1 output terminals 25A, or 2) one of the N BTB2 output terminals 26A. In the bus or the BTB failure mode all impacted BTB-Drop and BTB-Drop-Continue WDM service channels are routed without change, like in the normal mode. In the Bus Link failure mode each impacted WDM service channel routed on the local bus is switched by the Switch Fabrics 101F or 101G to the Switch Fabrics 101H that in turn switches it to one of the two: 1) one of the N BTB1 output terminals 25B, or 2) one of the N BTB2 output terminals 26B. WDM protection channels routed in the bus protection loops arrive at the Bus input terminals 100A and 100C and are optically demultiplexed, amplified and connected to the plurality of the input terminals 1B of the SBIN Switch 101A (101B) as shown on FIG. 12. The input terminals 1B are connected to the Switch Fabrics 101H in the first Switching Module or to further expansion Switching Modules not shown on FIG. 15, where each Switch Fabrics has 6N input terminals, 6N output terminals, and 2N input/output terminals. In the bus failure mode the SBIN Nodes in the impacted bus protection loops are signaled to execute protection cross-connects of the N 1B (11B) input terminals to: 1) N BTB1 output terminals 25A, or 2) N BTB2 output terminals 26A. In the bus failure mode the pass-through SBIN Nodes in the impacted bus protection loops are signaled to execute protection cross-connects of the N 1B (11B) input terminals to the N BTB1 output terminals 6 or 16, further routed to the correspondingly Bus output terminal 100B or 100D. In the BTB Link failure mode the SBIN Node detects the LOP BTB failure, or is signaled of the failure and executes the 1+1 DBI protection cross-connect to Merge the standby WDM channel as was explained on FIG. 3. A plurality of the input terminals 27A (27B) is connected to the Switch Fabrics 101H and to further Switching Module expension units not shown on FIG. 15. The terminals are cross connected to: 1) N output terminals 3A, or 2) N output terminals 13A, or 3) N output terminals 6 (16), or 4) N output terminals 25A or 26A, or 5) N output terminals 25B or 26B. On FIG. 14, a plurality of the Optical Switches 34 cross-connect WDM service channels 09 (019) that are the BTB-routed WDM channels back-to-back cross-connected by the local node such as for example the SBIN Node 101P on FIG. 4. The N output terminals 27A (27B) on FIG. 14 is connected to the corresponding N input terminals 27A (27B) of the Switch Fabrics 101H or to a further Switching Module expansion unit not shown on FIG. 15. The N Append1(2) input terminals 4A (14A) and the corresponding N Drop-Continue1(2) output terminals 4B (14B) are connected to the N optical Power Couplers 101D1, (101E1) and to Power Couplers in further Switching Module expansion units not shown on FIG. 15, each coupling power from two input terminals 5A (15A) and 4A (14A) and splitting it to the corresponding two output terminals 4B (14B), and 5 (15).

The smallest multi-bus network with 2 WDM channels, one service and one reserved protection (N=1) Adds/Drops one WDM channel to/from each bus direction (N=1) and Appends/Drop-Continues one WDM channel to/from each bus direction. It is designed with one Switching Module consisting of two 3×3 Switch Fabrics 101F,101G (6N=6 terminals) and one 6×8 Switch Fabrics 101H (6N+4N+2N+2N=14 terminals). In a practical implementation one could use 4×4 Switch Fabrics 101F,101G with two unused terminals in each of them used as follows: 1) Add/Drop terminals of the WDM service channels routed in the released by shared protection, protection bandwidth (B-WDM channels in the G-Buses and G-WDM channels in the B-Buses), or 2) a bidirectional loop-back connection, or 3) test terminals. In a practical implementation one could use an 8×8 Switch Fabrics 101H with two unused terminals that could be used as the test terminals. Adding more identical N=1 Switching Modules would in-service increase the size of the multi-bus network to 4,6,8,10,12,14,16 and possibly more WDM channels. Alternately the smallest multi-bus network with 4 WDM channels, two service and two reserved protection (N=2) Adds/Drops two WDM channels to/from each bus direction and Appends/Drop-Continues two WDM channels to/from each bus direction. It is designed with one Switching Module consisting of two 6×6 Switching Fabrics 101F, 101G (4N+2N=12 terminals) and one 12×16 Switch Fabrics 101H ((6N+2N)+(2N+4N)=28 terminals a practical implementation one could use an 8×8 Switch Fabrics 101F,101G leaving four unused terminals in each of them that could be used as follows: 1) Add/Drop terminals for the WDM service channels routed in the released by shared protection, protection bandwidth (B-WDM channels in the G-Buses and G-WDM channels in the B-Buses), or 2) a bidirectional loop-back connection, or 3) test terminals. In a practical implementation one could use a 16×16 Switch Fabrics 101H with four unused terminals that could be used as the test terminals. Adding more identical N=2 Switching Modules would in-service increase the size of the multi-bus network to 4,8,12,16 and possibly more WDM channels. Table in Appendix C expands table in Appendix A to show total capacity of a WDM multi-bus network with different number of expansion Switching Modules.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Appendix A

TABLE
Capacity of a DWDM-expanded WDM Channel

| Number | | | |
|---|---|---|---|
| of DWDM | DWDM | | WDM |
| signals in a | channel | maximum | channel |
| WDM | spacing | Bit-Rate | capacity |
| channel | [GHz] | [Gb/s] | [Gb/s] |
| 16 | 100 | 10 | 160 |
| 32 | 50 | 10 | 320 |
| 64 | 25 | 2.5 | 160 |

Appendix B

TABLE
Broadcasting of WDM Channels

| | | Drop1 | BTB1 | Drop-C1 | Bus1 | Drop2 | BTB2 | Drop-C2 | Bus2 |
|---|---|---|---|---|---|---|---|---|---|
| Figure | Input | 2B | 150B | 4B | 100B | 12B | 150D | 14B | 100D |
| 11A | App1 - 4A | | | X | X | | | | |
| 11A | App2 - 14A | | | | | | | X | X |
| 11A | Add1, 2 | | X | | | | | | |
| | 2A/12A | | X | X | X | | | | |
| | | | | | | | X | | |
| | | | | | | | X | X | X |
| 11B | Bus 1 | X | | | | | | | |
| | 100A | | X | | | | | | |
| | | | | X | X | | | | |
| | | | X | X | X | | | | |
| | | | | | | | X | | |
| | | | | | | | X | X | X |
| 11B | Bus 2 | | | | | X | | | |
| | 100C | | | | | | X | | |
| | | | | | | | | X | X |
| | | | | | | | X | X | X |
| | | | X | | | | | | |
| | | | X | X | X | | | | |
| 11C | BTB1 | X | | | | | | | |
| | protection | | X | | | | | | |
| | 150A | | X | X | X | | | | |
| | | | | | X | | | | |
| | | | | | | | X | | |
| | | | | | | | X | X | X |
| | | | | | | | | | X |
| 11C | BTB2 | | | | | X | | | |
| | protection | | | | | | X | | |
| | 150C | | | | | | X | X | X |
| | | | | | | | | | X |
| | | | X | | | | | | |
| | | | X | X | X | | | | |
| | | | | | X | | | | |
| 11D | BTB1, 2 | X | | | | | | | |
| | service | | | | | X | | | |
| | 150A/150C | X | | | | X | | | |
| | | | X | X | | | | | |
| | | | | | | | | X | X |
| | | | X | X | | | | X | X |
| | | | X | | | | | | |
| | | | | | | X | | | |
| | | | X | | | X | | | |
| | | | X | X | X | | | | |
| | | | | | | | X | X | X |
| | | | X | X | X | | X | X | X |

Appendix C

TABLE
Capacity of a DWDM-expanded WDM Multi-Bus Network

| | Number | | | | Total |
|---|---|---|---|---|---|
| | of DWDM | DWDM | | WDM | capacity of a |
| Number | signals | channel | Maximum | channel | single-bus |
| of WDM | in a WDM | spacing | Bit-Rate | capacity | network |
| channels | channel | [GHz] | [Gb/s] | [Gb/s] | [Tb/s] |
| 2 | 16 | 100 | 10 | 160 | 0.36 |
| 2 | 32 | 50 | 10 | 320 | 0.64 |
| 2 | 64 | 25 | 2.5 | 160 | 0.36 |
| 4 | 16 | 100 | 10 | 160 | 0.64 |
| 4 | 32 | 50 | 10 | 320 | 1.28 |
| 4 | 64 | 25 | 2.5 | 160 | 0.64 |
| 6 | 16 | 100 | 10 | 160 | 0.96 |
| 6 | 32 | 50 | 10 | 320 | 1.92 |
| 6 | 64 | 25 | 2.5 | 160 | 0.96 |
| 8 | 16 | 100 | 10 | 160 | 1.28 |
| 8 | 32 | 50 | 10 | 320 | 2.56 |
| 8 | 64 | 25 | 2.5 | 160 | 1.28 |
| 10 | 16 | 100 | 10 | 160 | 1.60 |
| 10 | 32 | 50 | 10 | 320 | 3.20 |
| 10 | 64 | 25 | 2.5 | 160 | 1.60 |
| 12 | 16 | 100 | 10 | 160 | 1.92 |
| 12 | 32 | 50 | 10 | 320 | 3.84 |
| 12 | 64 | 25 | 2.5 | 160 | 1.92 |
| 14 | 16 | 100 | 10 | 160 | 2.24 |
| 14 | 32 | 50 | 10 | 320 | 4.48 |
| 14 | 64 | 25 | 2.5 | 160 | 2.24 |
| 16 | 16 | 100 | 10 | 160 | 2.56 |
| 16 | 32 | 50 | 10 | 320 | 5.12 |
| 16 | 64 | 25 | 2.5 | 160 | 2.56 |

Appendix B (continue)

1. A process of all-optical two-fiber, bidirectional buses for networking of one optical wavelength Wavelength Division Multiplexed (WDM) or a plurality of optical wavelengths Dense Wavelength Division Multiplexed (DWDM) to each one of 2MN Wavelength Division Multiplexed (WDM) transmission channels in each transmission fiber, where M=1,2,3,4,5, . . . and N=1,2,3,4,5, . . . for a method of protected Point-To-Point, Point-To-Multipoint and Broadcast multi-bus networking comprising:
a Switching Bus Interface Node optical apparatus having first input/output bidirectional bus terminal in first bus direction and second input/output bidirectional bus terminal in second bus direction, said first and said second input bus terminals Wavelength Division Demultiplexed by the Transmit/Receive Interface to 2MN-first and 2MN-second bus input terminals and said first and said second bus output terminals Wavelength Division Multiplexed by said Transmit/Receive Interface from 2MN-first and 2MN-second bus output terminals, first and second input/output bidirectional bus-to-bus terminals said first and said second bus-to-bus output terminals Wavelength Division Multiplexed by said Transmit/Receive Interface from 2MN-first and 2MN-second bus-to-bus output terminals, MN-first add input terminals and MN-first drop output terminals in said first bus direction, MN-second add input terminals and MN-second drop output terminals in said second bus direction, MN-first append input terminals and MN-first drop-continue output terminals in said first bus direction, MN-second append input terminals and MN-second drop-continue output terminals in said second bus direction, and

2. The Switching Bus Interface Node optical apparatus of claim 1 with said in claim 1 said first and said second bidirectional bus-to-bus terminals for coupling said first bidirectional bus-to-bus terminal in said apparatus installed on in-between second bus with said first or said second bidirectional bus-to-bus terminal in said apparatus installed on first bus and for coupling said second bidirectional bus-to-bus terminal in said apparatus installed on said second bus with said first or said second bidirectional bus-to-bus terminal in said apparatus installed on third bus for protection networking of WDM channels between said second and said first buses, for service networking of WDM channels between said first and said third buses and for in-service network expansion by coupling not coupled said first or said second bidirectional bus-to-bus terminal in said apparatus installed on said first bus with said first or said second bidirectional bus-to-bus terminal in said apparatus installed on a fourth bus or by coupling not coupled said first or said second bidirectional bus-to-bus terminal in said apparatus installed on said third bus with said first or said second terminal in said apparatus installed on fifth bus comprising;
a method of partitioning of transmission bandwidth in each bus and bus-to-bus transmission fiber to first and second bandwidths, said first service bandwidth for service routing and said second protection bandwidth for protection routing on said in-between second bus, said first bandwidth for protection routing and said second bandwidth for service routing on said first and said third buses, and

3. The Switching Bus Interface Node optical apparatus of claim 1 with M identical Switching Module optical apparatuses, M=1,2,3,4,5, . . . , each apparatus (M=1) having identical first and second optical switches, third optical switch and N-first and N-second identical optical power couplers, N=1,2,3,4,5, . . . and comprising:
said first optical switch having N-first input terminals selected from said in claim 1 (M=1) 2N-first bus input terminals in said in claim 2 first or second service bandwidth on bus with installed said apparatus, said N-first add input terminals and said N-first drop output terminals, N-first through terminals for coupling to N-first optical power couplers, and 2N-third terminals for coupling to said third optical switch;
said second optical switch having N-second input terminals selected from said in claim 1 (M=1) said 2N-second bus input terminals in said in claim 2 service bandwidth on said bus with installed said apparatus, said N-second add input terminals and said N-second drop output terminals, N-second through terminals for coupling to N-second optical power couplers, and 2N-third terminals for coupling to said third optical switch;
said N-first optical power couplers each having first, second, third and fourth terminals to optically couple said first to said third and said fourth terminals and said second to said third and said fourth terminals, said first terminal for coupling to one of said N-first through terminals of said first optical switch, said second terminal for coupling to one of said in claim 4 N-second output terminals of first Bus-To-Bus Switch optical apparatus, said third terminal for coupling to one of said in claim 1 (M=1) N-first drop-continue output terminals, said fourth terminal for coupling to one of N-first bus output terminals selected from said in claim 1 (M=1) 2N-first bus output terminals in said in claim 2 service bandwidth on bus with installed said apparatus;
said N-second optical power couplers each having first, second, third and fourth terminals to optically couple said first to said third and said fourth terminals and said second terminal to said third and said fourth terminals, said first terminal for coupling to one of said N-second through terminals of said second optical switch, said second terminal for coupling to one of said in claim 4 N-second output terminals of second Bus-To-Bus Switch optical apparatus, said third terminal for coupling to one of said in claim 1 (M=1) N-second drop-continue output terminals, said fourth terminal for coupling to one of N-second bus output terminals selected from said in claim 1 (M=1) 2N-second bus output terminals in said in claim 2 service bandwidth on said bus with installed said apparatus;
said third optical switch having N-first bus input terminals selected from said in claim 1 (M=1) 2N-first bus input terminals in said in claim 2 protection bandwidth on bus with installed said apparatus, N-second bus input terminals selected from said in claim 1 (M=1) 2N-second bus input terminals in said in claim 2 protection bandwidth on said bus with installed said apparatus, N-third input terminals for coupling to said in claim 4 N-third output terminals of first Bus-To-Bus Switch optical apparatus, N-fourth input terminals for coupling to said in claim 4 N-third output terminals of second Bus-To-Bus Switch optical apparatus, 2N-fifth terminals for coupling to said 2N-third terminals of said first optical switch, 2N-sixth terminals for coupling to said 2N-third terminals of said second optical switch, N-seventh output terminals for coupling to N-first bus output terminals selected from said in claim 1 (M=1) 2N-first bus output terminals in said in claim 2 protection bandwidth on said bus with installed said apparatus, N-eighth output terminals for coupling to N-second bus output terminals selected from said in claim 1 (M=1) 2N-second bus output terminals in said in claim 2 protection bandwidth on said bus with installed said apparatus, N-ninth output terminals for coupling to N-first bus-to-bus output terminals selected from said in claim 1 (M=1) 2N-first bus-to-bus output terminals in said in claim 2 protection bandwidth on said bus with installed said apparatus, N-tenth output terminals for coupling to N-second bus-to-bus output terminals selected from said in claim 1 (M=1) 2N-second bus-to-bus output terminals in said in claim 2 protection bandwidth on said bus with installed said apparatus, N-eleventh output terminals for coupling to said in claim 4 N-first input terminals of first Bus-To-Bus Switch optical apparatus, N-twelfth output terminals for coupling to said in claim 4 N-first input terminals of second Bus-To-Bus Switch optical apparatus, and

4. Two identical first and second Bus-To-Bus Switch optical apparatuses, said first having M-first and M-second identical Bus-To-Bus Switching Module optical apparatuses, said second having said M-first and said M-second Bus-To-Bus Switching Module optical apparatuses, M=1,2,3,4,5, . . . comprising:
said first Bus-To-Bus Switching Module optical apparatus having N-first input terminals for coupling to said in claim 3 Switching Module optical apparatus, N-second input terminals for coupling to said in claim 1 (M=1) N-first append input terminals, N-third input terminals for coupling to said in claim 6 (M=1) N-first bus-to-bus input terminals, N-first output terminals for coupling to N-first bus-to-bus output terminals selected from said in claim 1 (M=1) 2N-first bus-to-bus output terminals in said in claim 2 service bandwidth on said bus with installed said apparatus, N-second and N-third output terminals for coupling to said in claim 3 Switching Module optical apparatus:
said second Bus-To-Bus Switching Module optical apparatus having N-first input terminals for coupling to said in claim 3 Switching Module optical apparatus, N-second input terminals for coupling to said in claim 1 (M=1) N-second append input terminals, N-third input terminals for coupling to said in claim 6 (M=1) N-second bus-to-bus input terminals, N-first output terminals for coupling to N-second bus-to-bus output terminals selected from said in claim 1 (M=1) 2N-second bus-to-bus output terminals in said in claim 2 service bandwidth on said bus with installed said apparatus, N-second and N-third output terminals for coupling to said in claim 3 Switching Module optical apparatus:

5. Two identical first and second Bus-To-Bus Switching Module optical apparatuses of claim 4 each one comprising:
N optional optical amplifiers each having first and second terminals, said first terminal for coupling to one of said in claim 4 N-first input terminals, said second optical terminal for coupling to one of N-first optical power couplers;
N-first optical power couplers each having first, second, third and fourth terminals to optically couple said first to said third and said fourth terminals and said second to said third and said fourth terminals, said first terminal for coupling to one of said N optical amplifiers, said second terminal for coupling to one of N-first 1:2 optical switches, said third terminal for coupling to one of N-second 2:1 optical switches, said fourth terminal for coupling to one of said in claim 4 N-first output terminals;
said N-first 1:2 optical switches each having first, second and third terminals to selectively optically couple said first and said second terminals or said first and said third terminals, said first terminal for coupling to one of said in claim 4 N-second input terminals, said second terminal for coupling to said second terminal of one of said N-first optical power couplers, said third terminal for coupling to first terminal of one of N-second optical power couplers;
said N-second 2:1 optical switches each having first, second and third terminals to selectively optically couple said first and said third terminals or said second and said third terminals, said first terminal for coupling to said third terminal of one of said N-first optical power couplers, said second terminal for coupling to said second terminal of one of N-third optical switches, said third terminal for coupling to second terminal of one of N-second optical power couplers;
said N-third 1:2 optical switches each having first, second and third terminals to selectively optically couple said first and said second terminals or said first and said third terminals, said first terminal for coupling to one of said in claim 4 N-third input terminals, said second terminal for coupling to said second terminal of one of said N-second optical switches, said third terminal for coupling to one of said in claim 4 N-third output terminals;
said N-second optical power couplers each having first, second and third terminals to optically couple said first to said third terminal and said second to said third terminal, said first terminals for coupling to said third terminal of one of said N-first 1:2 optical switches, said second terminal for coupling to said third terminal of one of said N-second 2:1 optical switches, said third terminal for coupling to one of said N-second output terminals;

6. The Switching Bus Interface Node optical apparatus of claim 1 with a Bus-To-Bus Broadcast optical apparatus having first and second input terminals for coupling to said in claim 1 said first and said second bus-to-bus input terminals, and third, fourth, fifth and sixth output terminals, said third and said fourth output terminals for coupling to first and second power coupler optical apparatuses, said fifth and said sixth output terminals further Wavelength Division Demultiplexed by the Transmit/Receive Interface to MN-first and MN-second bus-to-bus input terminals with WDM channels selected from said in claim 2 service bandwidth on bus with said apparatus, M=1,2,3, . . . , N=1,2,3, . . . comprising;
said first power coupler optical apparatus having first, second, third and fourth terminals to optically couple said first to said third and said fourth terminals and said second to said third and said fourth terminals, said first terminal for coupling to said in claim 1 first bus input terminal, said second terminal for coupling to said third terminal of said Bus-To-Bus Broadcast optical apparatus, said third terminal for coupling to a Line Interface, said fourth terminal for coupling to input terminal of said in claim 1 WDM Demultiplexer of said first bus input terminal;
said second power coupler optical apparatus having first, second, third and fourth terminals to optically couple said first to said third and said fourth terminals and said second to said third and said fourth terminals, said first terminal for coupling to said in claim 1 second bus input terminal, said second terminal for coupling to said fourth terminal of said Bus-To-Bus Broadcast optical apparatus, said third terminal for coupling to a Line Interface, said fourth terminal for coupling to input terminal of said in claim 1 WDM Demultiplexer of said second bus input terminal;
first optical sub-band filter having first, second and third terminals to optically filter MN WDM channels in the same as said in claim 2 protection bandwidth on bus with said apparatus from said first terminal to said second terminal, to optically filter MN WDM channels in the same as said in claim 2 service bandwidth on said bus with said apparatus from said first terminal to said third terminal, said first terminal for coupling to said first input terminal, said second terminal for coupling to said third output terminal, said third terminal for coupling to first terminal of optical power coupler;
second optical sub-band filter having first, second and third terminals to optically filter MN WDM channels in the same as said in claim 2 protection bandwidth on bus with said apparatus from said first terminal to said second terminal, to optically filter MN WDM channels in the same as said in claim 2 service bandwidth on said bus with said apparatus from said first terminal to said third terminal, said first terminal for coupling to said second input terminal, said second terminal for coupling to said fourth output terminal, said third terminal for coupling to second terminal of optical power coupler;
said optical power coupler having first, second, third and fourth terminals to optically couple said first to said third and said fourth terminals and said second to said third and said fourth terminals, said first terminal for coupling to said third terminal of said first optical sub-band filter, said second terminal for coupling to said third terminal of said second optical sub-band filter, said third terminal for coupling to said fifth output terminal, said fourth terminal for coupling to said sixth output terminal.
